(19) United States
(12) Patent Application Publication
(10) Pub. No.: US 2010/0242299 A1
(43) Pub. Date: Sep. 30, 2010

(54) UV CURING SYSTEM AND PROCESS

(75) Inventor: Stephen B. Siegel, Chicago, IL (US)

Correspondence Address: PATENT ADMINISTRATOR;NEAL, GERBER, & EISENBERG, SUITE 1700, 2 NORTH LASALLE STREET, CHICAGO, IL, 60602, US

(73) Assignee: CON-TROL-CURE, Inc., Chicago, IL (US)

(21) Appl. No.: 12/762,916

(22) Filed: Apr. 19, 2010

Related U.S. Application Data
(63) Continuation-in-part of application No. 12/050,616, filed on Mar. 18, 2008, now abandoned.
Application No. 12/050,616 is a division of application No. 10/753,837, filed on Jan. 7, 2004, now abandoned.
Application No. 10/753,837 is a continuation-in-part of application No. 10/386,980, filed on Mar. 12, 2003, now abandoned.
Application No. 10/386,980 is a continuation-in-part of application No. 10/339,264, filed on Jan. 9, 2003, now Pat. No. 7,175,712.

(51) Int. Cl. F26B 3/34

(52) U.S. Cl. 34/275

(57) ABSTRACT

A rotatably indexable and stackable apparatus and method for UV curing an elongated member or at least one UV-curable ink, coating or adhesive applied thereon is further disclosed, comprising at least one UV-LED mounted on one side of the elongated member, and an elliptically-shaped reflector positioned on the other side of the elongated member opposite the at least one UV-LED.

### CROSS REFERENCE

This application is a continuation-in-part of U.S. application Ser. No. 12/050,616 filed Mar. 18, 2008 for “Rotary UV Curing Method And Apparatus,” which is a divisional of U.S. application Ser. No. 10/753,837 filed Jan. 7, 2004 for “Rotary UV Curing Method And Apparatus,” now abandoned, which is a continuation-in-part of U.S. application Ser. No. 10/386,980 filed Mar. 12, 2003 for “Multiple Wavelength UV Curing,” now abandoned, which is a continuation-in-part of U.S. application Ser. No. 10/339,264 filed Jan. 9, 2003 for “Light Emitting Apparatus and Method For Curing Inks, Coatings And Adhesives,” now issued as U.S. Pat. No. 7,175,712, all of which are incorporated herein by reference in their entirety.

### BACKGROUND OF THE INVENTION

1. Field of the Invention

The present invention relates to a method for ultraviolet (UV) curing of inks, coatings and adhesives having UV photo initiators therein which, when exposed to UV light, convert monomers in the inks, coatings and adhesives to linking polymers to solidify the monomer material and which are placed on a variety of products using one or more ultraviolet light-emitting diode (UV-LED) modules, which may include one or more super high power UV-LED's. More specifically, the present invention relates to a method for UV curing of inks, coatings or adhesives on optical fibers, wires, cables, tubes, tubing, hoses, pipes, compact discs (discs) (CDs), digital video discs (discs) (DVDs), golf balls, golf tees, string instruments, eye glass lenses, contact lenses, decorative labels, peelable labels, stamps, doors, countertops, and other products using one or more UV-LED modules.

The present invention also relates to a method and apparatus for utilizing ultraviolet (UV) light to cure a disk-shaped product using UV-LED chips mounted in an array and providing for relative movement between the array and the disk-shaped product, thereby to cure a curable ink, coating or adhesive mounted in the disk-shaped product. The inks, coatings and adhesives have UV photo initiators which, when exposed to UV light, convert monomers in the inks, coatings and adhesives to linking polymers to solidify the curable material.

2. Description of the Related Art

Heretofore, UV light-emitting diodes (LEDs) and UV lamps have been proposed for supplying UV light for curing UV curable inks, coatings and adhesives on various products. Many of the prior art techniques are time-consuming and inefficient and can cause uneven curing of the products.

It is, therefore, desirable to provide an improved UV curing method and apparatus which overcomes most, if not all, of the preceding problems.

The prior proposals teach one to stagger rows of UV-LED's in different arrays on a panel positioned closely adjacent a product to be cured, to move the product past the array, to move the array in a generally orbital path to uniformly apply UV light on the product and to inject an inert, heavier than air or lighter than air gas in the area between the panel and the product.

Also it has been learned that different wavelengths of UV light are better suited for different thicknesses of ink, coating or adhesive and/or for different components in the ink coating or adhesive.

For example, thick polymers require longer wavelengths for curing. Surface curing requires shorter wavelengths.

Further, a common use of UV curable adhesives and coatings is in the manufacture of compact disks, CD's.

It is, therefore, desirable to provide an improved UV method and apparatus for applying UV light at one or more wavelengths to a disk-shaped UV curable product to more effectively cure UV inks, coatings and adhesives in or on the product, by causing relative rotation between the UV light and the disk-shaped product.

### BRIEF SUMMARY OF THE INVENTION

An improved ultraviolet (UV) curing method and apparatus are provided which quickly, efficiently and effectively cures UV curable products, articles, inks, coatings, adhesives, and other objects. Advantageously, the user-friendly UV curing method and apparatus are economical, dependable and easy-to-use.

In the novel method and apparatus, substantially uniform continuous or intermittent blasts or pulses of high intensity UV light are emitted from UV light emitters in one or more UV curing apparatus at a substantially constant output level and intensity along one or more UV light paths. The UV light emitters are super high power UV-LED modules with high intensity UV-LED chips. Significantly, the high intensity UV-LED chips are prevented from being positioned opposite each other and in the path of the high intensity UV light so that the high intensity UV light does not contact and degrade the high intensity UV-LED chips. The UV curable products, articles, inks, coatings, adhesives, and other objects can be intermittently, sequentially or continuously positioned in the UV light path. Desirably, the UV light is substantially uniformly applied and distributed on the UV curable products, articles, inks, coatings, adhesives, and other products in the UV light path. Advantageously, thereafter, the UV curable products, articles, inks, coatings, adhesives, and other objects are partially or fully substantially uniformly and evenly polymerized, set and cured in the UV-light path with the intermittent blasts or pulses of UV light.

In the preferred method and apparatus, the temperature of the UV light emitters, UV curing apparatus, or UV light is controlled with one or more high power, water cooled UV-LED modules through which distilled water is pumped. The high power UV-LED module can be the module manufactured and sold by NICHIA Corporation of Tokushima Japan under model no. NLBU21WO1-E1.

The UV curable products, articles, inks, coatings, adhesives, and other objects can be conveyed by a conveyor in the light path. The UV curable products, articles, inks, coatings, adhesives, and other objects can also be spun or rotated in the light path to enhance uniform distribution and application of UV light and curing on the UV curable products, articles, inks, coatings, adhesives, and other objects. In some circumstances, such as for some types of UV printing, it may be desirable to position, stop, or maintain the UV curable products, articles, inks, coatings, adhesives, and other objects in a stationary fixed location and position on the UV light path during curing.

The novel UV curing method is particularly useful to cure clear transparent scratch-resistant UV curable coatings and/or printing of names, trademarks, logos, and/or designs of black or colored UV curable ink on various products, such as: optical fibers, wires, cables, tubes, tubing, hoses, pipes, compact discs (CDs) including audio discs and computer discs, digital video discs (DVDs), golf balls, golf tees, eye glass lenses, UV curable soft hydroscopic contact lenses, doors, countertops, guitars and other string instruments, decorative labels, peelable labels and peelable stamps i.e. labels that can be readily peeled, removed, stripped, or detached from an underlying sheet or backing sheet.

According to another embodiment of the present invention, there is provided a method and apparatus for curing a UV curable product, article, ink coating or adhesive in or on a disk including the step of or mechanisms for causing relative rotational movement between an array of UV-LED chips mounted on a panel and a disk containing the UV curable product, article, ink coating or adhesive.

Also, there may be at least one staggered array of UV LED assemblies on at least one panel with the UV LED assemblies being arranged in rows with each row being staggered from adjacent rows. A mechanism is provided for causing relative rotational movement between the panel and a disk-shaped product.

In another embodiment, the disk-shaped product containing the UV curable product, article or other object to be cured is arranged to rotate. A gas having a molecular weight heavier than air or lighter than air can be injected into the area of rotation of the UV curable product, article or other object having a UV ink, coating, or adhesive thereon as it rotates past a panel of arrays of UV LED assemblies.

In a further embodiment, the panel or a + shaped (cross-shaped) structure comprising four panels is caused to rotate relative to the disk-shaped product.

Advantageously, the method and apparatus of the present invention provide better uniformity of light application from a flat panel having an array of UV-LED's. This result can be obtained when the product and/or the light fixture is rotated relative to and across the UV light beams from the UV-LED assemblies. The rotational movement has the ability to provide enhanced uniformity. Desirably, the rotation of the UV curable product or the rotation of the light array provides outstanding uniformity of UV light and UV curing of the product.

In another embodiment, an apparatus for ultraviolet (UV) curing an elongated member, such as an optical fiber, wire, tubing, tube, hose or pipe, or at least one UV-curable ink, coating or adhesive applied thereon is disclosed. The apparatus comprises at least one ultraviolet light-emitting diode (UV-LED) mounted on one side of the elongated member, and an elliptically-shaped reflector positioned on the other side of the elongated member opposite the at least one UV-LED. The at least one UV-LED is positioned proximate to a first focus of the elliptically-shaped reflector and the elongated member is positioned proximate to a second focus of the elliptically-shaped reflector.

The at least one UV-LED may comprise at least one high intensity UV-LED. The at least one UV-LED may alternatively comprise a plurality of UV-LED's formed in a linear array. The at least one UV-LED may include a dominant wavelength lying in the range of approximately 180 nm to approximately 420 nm within the ultraviolet and visible spectrums. The at least one UV-LED may alternatively include a dominant wavelength lying in the range of approximately 390 nm to approximately 405 nm within the ultraviolet and visible spectrums.

The apparatus may further include a mount plate upon which the at least one UV-LED and the elliptically-shaped reflector are mounted to form a UV-LED module. A plurality of UV-LED modules may be positioned about the elongated member in a staggered array with the at least one UV-LED associated with a UV-LED module being rotated to a selectable angle relative to the at least one UV-LED associated with an adjacent UV-LED module. The apparatus may include an indexing and joining apparatus for rotatably indexing and engaging the UV-LED module to at least one adjacent UV-LED module in a stacked array. When stacked, the distance between the elongated member and each of the at least one UV-LED in each of the UV-LED modules may be approximately the same.

The elliptically-shaped reflector may be made from an anodized aluminum that is capable of reflecting at least 85% of the light it receives from the at least one UV-LED. The apparatus may further include a transparent tube positioned around the elongated member. The transparent tube may be made of quartz and include an inert gas therewithin. The transparent tube may be approximately coaxial with the elongated member and the second focus of the elliptically-shaped member. The apparatus may further include a light sensor coupled to an electronic controller for measuring a light intensity emitted from the at least one UV-LED and for adjusting the light intensity to optimally cure the elongated member or the at least one UV-curable ink, coating or adhesive applied thereon.

In yet another embodiment, a method for ultraviolet (UV) curing an elongated member, such as an optical fiber, wire, tubing, tube, hose or pipe, or at least one UV-curable ink, coating or adhesive applied thereon is disclosed, comprising the steps of positioning an elliptically-shaped reflector on one side of the elongated member, positioning at least one ultraviolet light-emitting diode (UV-LED) in proximity to and on another side of the elongated member at approximately a first focus of the elliptically-shaped reflector, and emitting UV light from the UV-LED onto the elongated member.

The method may include the step of positioning a transparent tube around the elongated member, the elongated member potentially being positioned proximate to a second focus of the elliptically-shaped reflector. The method may also include the step of substantially filling the transparent tube with an inert gas. The method may further include the step of mounting the at least one UV-LED and the elliptically-shaped reflector to a housing to form a UV-LED module.

The method may include the step of positioning a plurality of UV-LED modules about the elongated member, where each of the at least one UV-LED associated with the UV-LED module may be positioned inline with the at least one UV-LED associated with an adjacent UV-LED module or at a selectable angle relative to the at least one UV-LED associated with an adjacent UV-LED module

A more detailed explanation of the invention is provided in the following detailed description and claims taken in conjunction with the accompanying drawings.

### BRIEF DESCRIPTION OF THE SEVERAL VIEWS OF THE DRAWINGS

FIG. 1. is a perspective view of a super high power UV-LED module that emits high intensity UV light.

FIG. 2. is an end view of the super high power UV-LED module positioned adjacent a quartz tube having an optical fiber therein with an aluminum reflector positioned on the other side of the quartz tube.

FIG. 3. is a perspective view of 4 super high power modules and 4 reflectors positioned about a quartz tube in a staggered array, each module being 90 degrees from the adjacent module.

FIG. 4 is a front elevational sectional view of a mandrel mounting two discs which are glued or bonded together to form a DVD and illustrates upper and lower UV-LED modules positioned for radial movement relative to the discs for curing adhesive between the discs as the discs are rotated.

FIG. 5. is a perspective view of the mandrel and DVD shown in FIG. 4 and shows a mechanism for moving the super high power modules radially inwardly and outwardly relative to the DVD on the mandrel.

FIG. 6 is a perspective view of super high power UV-LED module assemblies positioned above and adjacent a conveyor carrying golf balls which are also rotating on the conveyor and which have a UV curable coating thereon.

FIG. 7 is a perspective view of a super high power UV-LED module assembly positioned over a portion of a conveyor carrying golf tees which have been coated and/or printed with a UV curable material.

FIG. 8 is a perspective view similar to the view shown in FIG. 7 illustrating a super high power UV-LED module assembly positioned over a portion of a conveyor containing string instrument necks which have a UV curable coating thereon.

FIG. 9 is a perspective view showing a super high power UV-LED module assembly positioned above and adjacent a conveyor carrying coated eye glass lens.

FIG. 10 is a perspective view of a super high power UV-LED module assembly positioned above and adjacent a conveyor carrying contact lens which are made of or have a coating made of a UV curable material.

FIG. 11 is a cross-section of one form of carrier for the contact lens carried on the conveyor as shown in FIG. 10.

FIG. 12 is a perspective view of a super high power UV-LED module assembly positioned over a conveyor carrying labels which have a UV adhesive and a backing material beneath the label.

FIG. 13 is a view similar to the view shown in FIG. 11 and shows a super high power UV-LED module assembly positioned over a conveyor carrying labels for curing UV curable print (ink) on the label.

FIG. 14 is a perspective view of a super high power UV-LED module assembly positioned along a portion of a conveyor carrying doors which have been coated with a UV curable coating.

FIG. 15 is a perspective view of a super high power UV-LED module assembly positioned over a portion of a conveyor carrying countertops which have been coated with a UV curable coating.

FIG. 16 is a top plan view of a panel or substrate mounting an array of UV-LED chips positioned above a disk-shaped product, which is caused to rotate underneath the array.

FIG. 17 is a vertical sectional view through the disk and panel or substrate shown in FIG. 16 and also shows a dispensing apparatus for dispensing liquid having a UV photo initiator therein onto the disk-shaped product as it rotates under the dispensing apparatus.

FIG. 18 is a top plan view of a + shaped (cross-shaped) arrangement of four panels each having an array of UV-LED chips mounted thereon for rotation above a disk.

FIG. 19 is a vertical, partially sectional view of the cross-shaped panel assembly shown in FIG. 18 and shows a glass or plastic shield between the UV-LED chips in the four arrays and the disk therebeneath and also shows an auxiliary array of UV-LED chips on the side of the disk and a glass or plastic protecting shield between the auxiliary array and the side of the disk.

FIG. 20 is a perspective view of an embodiment of a rotatably indexable and stackable UV-LED module for curing an elongated member or any UV-curable ink, coating or adhesive applied thereon.

FIG. 21 is a top plan view of the embodiment of FIG. 20 showing placement of an UV-LED light source at approximately one focus of an ellipse formed by an elliptically-shaped reflector.

FIG. 22 is a top plan view of another embodiment of FIG. 20 showing placement of an UV-LED light source at approximately one focus of a different ellipse formed by an elliptically-shaped reflector.

FIG. 23 is a top plan view of one embodiment of a mount plate of the UV-LED module of FIG. 20.

FIG. 24 is a top plan view of one embodiment of an end plate for connecting together multiple units of the UV-LED module of FIG. 20.

FIG. 25 is a partial section view showing multiple units of the UV-LED module of FIG. 20 stacked together.

FIG. 26 is a top plan view of another embodiment of a mount plate for use in connection with the UV-LED module of FIG. 20.

FIG. 27 is a top plan view of one embodiment of a holding plate for use in connection with the UV-LED module of FIG. 20.

FIG. 28 is a top plan view of the embodiment of FIG. 21 having a light sensor.

FIG. 29 is a perspective view of yet another embodiment of a rotatably indexable and stackable UV-LED module for curing an elongated member or any UV-curable ink, coating or adhesive applied thereon.

### DETAILED DESCRIPTION OF THE INVENTION

A detailed description of the preferred embodiments and best modes for practicing the invention are described herein.

UV-LED's (ultraviolet light emitting diodes) are being used more and more for curing UV curable inks, coatings and adhesives on a variety of different products. Typically such LED's are 0.346 mm². Also they typically are powered with three to five volts and a power drain of 30 milliwatts.

The power output of LED's is being increased so that higher intensity UV light can be emitted by the LED's. As a result, new arrays of UV LED's require more driving power, emit more light and generate more heat. Furthermore, new super high power UV-LED modules are considerably more expensive than the earlier modules with smaller, less inexpensive lower power UV-LED chips that emit low intensity UV light. With small, inexpensive lower power UV-LED chips it is practical to use hundreds or even thousands, e.g., 10,000, chips to create an array of low power UV-LED's to illuminate a product for curing.

New high power UV-LED chips that emit high intensity UV light are being driven with 1 amp rather than 30 milliamps. This is an enormous increase in current and power, but a considerable amount of heat is generated. Methods of applying UV light to a UV curable polymer can now be accomplished with smaller arrays of high power UV-LED chips to evenly expose the UV curable products by either moving the LED array or moving the UV curable products.

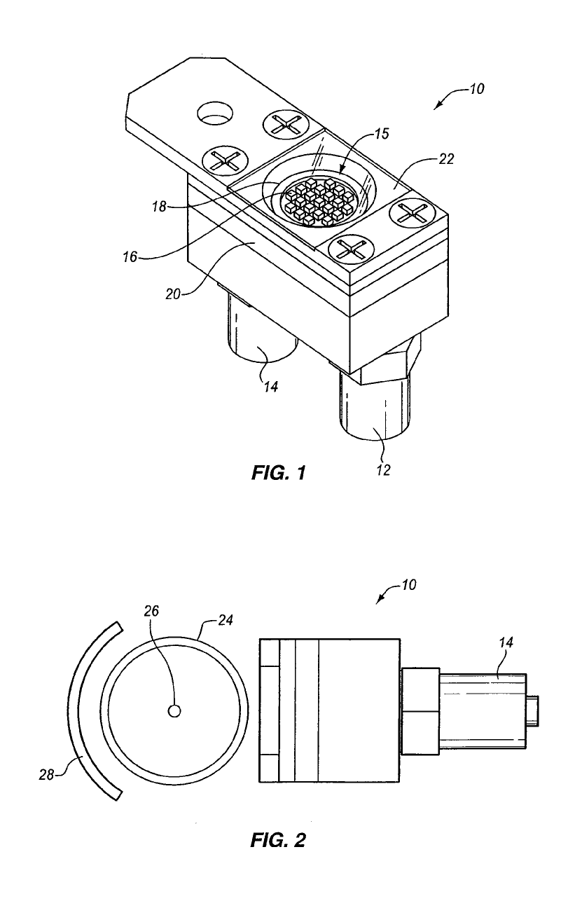

In FIG. 1 there is illustrated a super high power 21 chip UV-LED module 10 of the type manufactured and sold by NICHIA Corporation of Tokushima Japan under model no. NLBU21WO1-E1. The method and apparatus of the present invention make advantageous use of this UV-LED module 10. The module 10 uses 5 watts of power with a sharp operating spectrum of 365 nm, an operating voltage of approximately 6 volts and an operating current of 21 amps.

As shown, the module 10 has water inlets and outlets 12 and 14 to enable cooling water to be circulated beneath an array 15 of twenty one (21) UV-LED chips (UV LED's) 16 which are mounted in a recess 18 in a body 20 of the module 10 and covered with a quartz protector plate 22. The water pressure is approximately 250 kPa and is circulated through the module 10 at an average temperature of 25 degrees centigrade in order to dissipate the heat from the LED's 16 on the module 10.

Referring now to FIG. 2, the super high power UV-LED module 10 is shown positioned adjacent to a transparent, quartz tube 24 in the center of which is arranged an optical fiber 26 (or wire, tubing, tube, hose or pipe). The optical fiber 26 can be pulled through the quartz tube 24 from top to bottom or from bottom to top of the quartz tube 24 and the quartz tube 24 can be arranged vertically. An aluminum, curved reflector 28 is positioned opposite the array 15 (FIG. 1) of UV LED's 16 in the module 10 to reflect light back against the optical fiber 26 (FIG. 2). According to the teachings of the present invention, the array 15 (FIG. 1) of UV-LED's 16 is positioned so as not to direct UV light against other UV-LED's 16, since the high intensity UV light can damage the UV-LED chips 16. Additionally, it is to be understood that the optical fiber 26 (FIG. 2) can be rotated as it is moved through the quartz tube 24. Further, it will be understood that the optical fiber 26 (or wire, tubing, tube, hose or pipe) is coated with a UV curable coating or has an UV curable ink thereon.

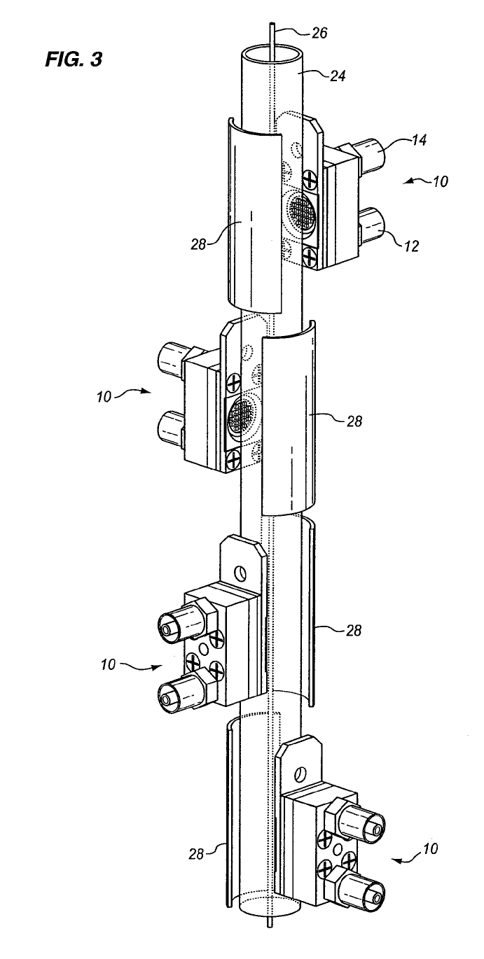

In the embodiment shown in FIG. 3, four (4) modules 10 are positioned about the quartz tube 24, which is arranged vertically with the optical fiber 26 (or wire, tubing, tube, hose or pipe) positioned generally centrally within the quartz tube 24. The super high power UV-LED modules 10 are positioned opposite the reflectors and are staggered around the quartz tube 24 such that each adjacent module 10 is rotated 90 degrees from the adjacent module 10 as shown in FIG. 3.

In one embodiment, the interior of the quartz tube 24 is filled with an inert gas, such as nitrogen, to keep the optical fiber 26 (wire, tubing, tube, hose or pipe) oxygen free to facilitate curing of the UV curable material coating or ink on the optical fiber 26 (or wire, tubing, tube, hose or pipe).

At the exit end of the quartz tube 24, the optical fiber 26 is pulled through a valve, similar to a hemostasis valve so that the nitrogen can be kept in the quartz tube 24. If the inert gas is heavier than air, the inert gas can be injected into the top of the glass of the quartz tube 24 and the valve can be located at the lower end of the quartz tube 24 such that the optical fiber is pulled through the quartz tube 24 from top to bottom.

On the other hand, if the inert gas used is lighter than air, the optical fiber 26 (wire, tubing tube, hose or pipe) can be pulled from bottom to top and the valve can be located at the top of the quartz tube 24. If the inert gas is heavier than air, the inert gas can be injected into the bottom end of the quartz tube 24. Alternatively, the inert gas can be circulated through the curing area of the quartz tube 24.

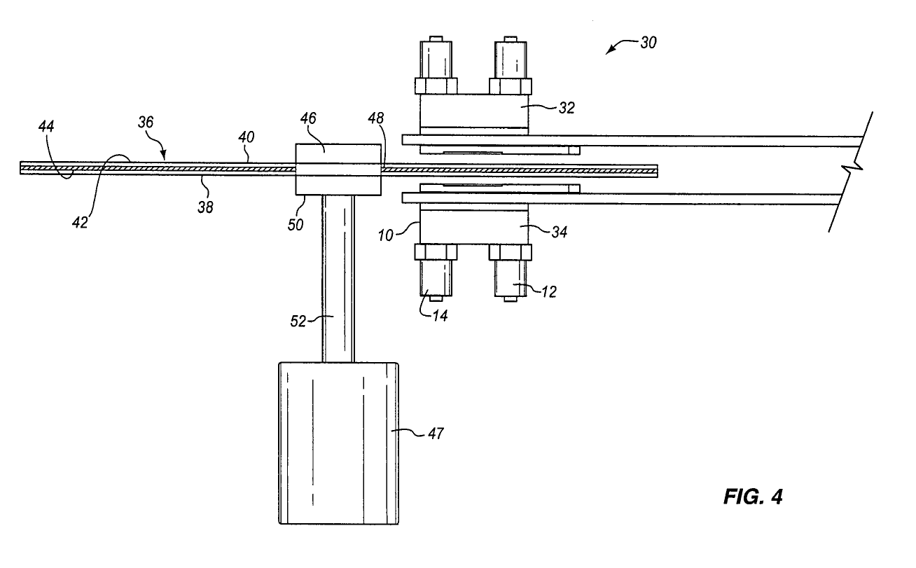

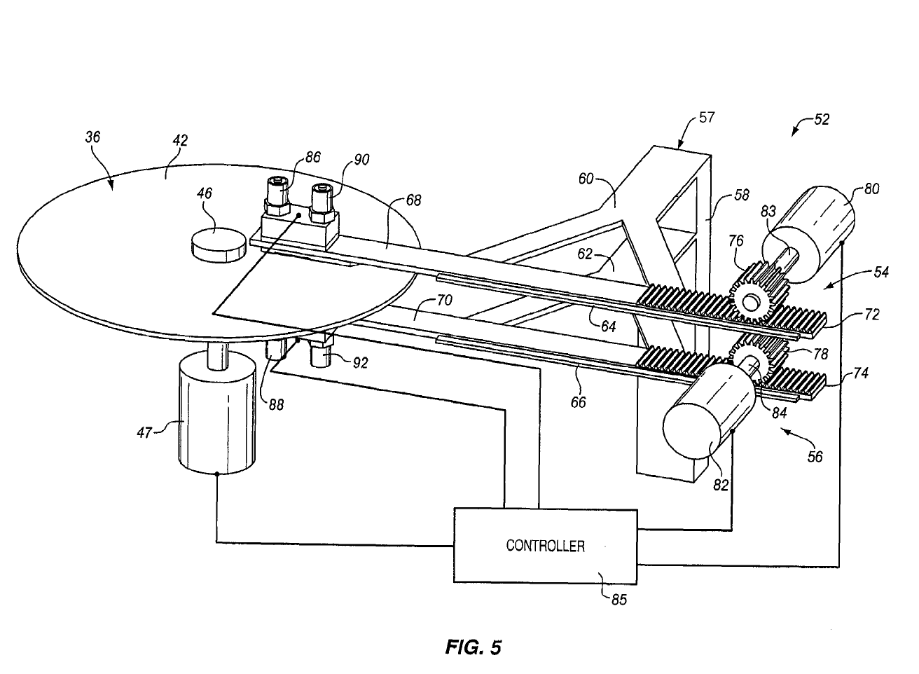

In FIG. 4, a UV curing system 30 uses two super high power UV-LED modules 10, namely an upper module 32 and a lower module 34 for curing a CD or DVD 36. The DVD can comprise a lower first transparent plastic disc 38 having an upper, aluminum, data carrying layer 40 and an upper second transparent plastic disc 42 having a lower aluminum data carrying layer 44. In the construction of the DVD 36, the lower disc 38 can be fixed on a mandrel 46 driven by a motor 47 and a ring of UV curable adhesive 48 can be placed on the aluminum data carrying layer 40 adjacent a hub 50 of the mandrel 46. Then the upper disc 42 can be placed over the lower disc 38 with the aluminum data carrying layer 44 of the upper disc 42 facing the aluminum data carrying layer 40 of the lower disc and facing the ring of adhesive 48. The mandrel 46 can be driven by a motor 52 connected thereto to cause the mandrel 46 to rotate the discs 38 and 42 which causes the UV curable adhesive 48 to flow radially outwardly under centrifugal force. This causes the upper disc 42 to move or press downwardly toward the lower disc 38 as a thin layer of the adhesive 48 is established between the upper and lower discs 38 and 42 by the centrifugal force. While the mandrel 46 is rotating, the upper and lower UV-LED modules 32 and 34 are caused to move inwardly and outwardly, relative to the rotating discs 38 and 42 by a reciprocating mechanism 52 (FIG. 5).

As shown in FIG. 5, the reciprocating mechanism 52 for moving the UV LED modules 32 and 34 comprises a two rack and pinion mechanisms 54 and 56 mounted on a support structure 57. The support structure 57 includes an upright post 58 from which extends spaced apart upper and lower Y-shaped arms 60 and 62. Each arm 60 and 62 mounts a horizontally disposed track 64 or 66. Each track 64 or 66 slidably supports a rail 68 or 70 including a rack 72 or 74 of one of the rack and pinion mechanisms 54 and 56. Each rack and pinion mechanism 54, 56 also includes a pinion 76 or 78 that engages the rack 72 or 74 on one of the rails 68 or 70. The pinions 76 and 78 are driven, respectively, by motors 80 or 82 via shafts 83 and 84 that are suitably supported adjacent the racks 72 and 74.

A controller 85 (FIG. 5) is eclectically coupled to the motors 47, 80 and 82, as well as to the UV-LED arrays in each of the super high power UV-LED modules 32 and 34. Activation and de-activation (turning on and turning off) of the super high power UV-LED modules, as well as controlling the speed of rotation of the motor 47, and turning on and off of the motors 80 and 82 are controlled by the controller 85. This radial movement of the modules 32 and 34 is synchronized with the rotation of the motor 47 driving the mandrel 46 to ensure complete curing of the UV curable adhesive 48 between the discs 38 and 42.

It is to be understood that as much as 80% of the high intensity UV light from the high power UV-LED arrays may be blocked by the aluminum data carrying layer 40 or 44 (FIG. 4) of the DVD. However the 20% of the high intensity UV light that gets through to the aluminum data carrying layer 40 or 44 is sufficient to cure the adhesive 48.

As with the UV LED modules 10 shown in FIG. 3, each of the UV LED modules 32 and 34 has a cooling water input 86 or 88 (FIG. 5) and a cooling water output 90 or 92 which are connected to hoses (not shown) that are carried on the rails 68 and 70 to the support structure 57, and from there to water inlets and outlets and to a source of pressurized water.

In operation, after the upper disc 42 (FIG. 4) and lower disc 38 are positioned on the mandrel 46, the motor 47 is turned on as well as the motors 80 and 82 (FIG. 5) and power to the UV-LED modules 32 and 34 is turned on as well as a water pumping system (not shown) for supplying pressurized cooling water to the UV-LED modules 32 and 34. While the mandrel is rotated, the UV LED modules 32 and 34 are caused to move radially outwardly from the center of the mandrel 46 while a high intensity UV light in the spectrum of 365 nm is directed toward the discs 38 and 42.

As mentioned above, about eighty percent (80%) of the high intensity UV light can be absorbed by the aluminum data carrying layers of the DVD. However approximately twenty percent (20%) of the high intensity UV light can pass through the aluminum data carrying layer to cure the UV curable adhesive 48 in the DVD. The cured DVD is then ejected from the mandrel and the process is repeated starting with another placement of another lower disc 38 on the mandrel 46.

From the foregoing description it will be understood that the high intensity UV LED module can be used for curing inks, coatings or adhesives on elongated structures such as optical fibers, wires, tubes, tubing, hoses or pipes which are pulled through a quartz tube 24 having an inert gas therein and a hemostasis type valve at one end thereof. Also the super high power UV-LED modules can be used to cure CD's or DVD's as illustrated by the UV curing system shown in FIGS. 4 and 5. The super high power UV-LED modules or an assembly thereof or a modification thereof also can be used in UV curing systems of the type for curing eye glass lens, contact lens, golf balls, golf tees, necks for string instruments, labels, peelable labels, doors and countertops. In such curing systems arrays of high power UV LED's are mounted on a cooling module in staggered or overlapping arrays and over or adjacent a conveyer while the object or product having a UV curable ink coating or adhesive thereon passes under or adjacent the high power UV LED assembly.

The opposing arrays are arranged so they are not opposite and facing each other as the high intensity UV light can degrade the high intensity UV-LED chips. An optical fiber can be exposed to several, e.g. 4 arrays, which are alternatively positioned so each array irradiates a portion of the optical fiber, as the optical fiber moves past the high power UV-LED array. Advantageously, the UV-LED's focus is directed onto a reflector with the optical fiber (wire) located between the array and the reflector.

Rather than creating an array in the area of a 5 inch circle for a CD/DVD, it is more desirable to spin the CD/DVD and to transverse a UV-LED array across the spinning disc as in the embodiment described above. The same application for “hard coats” can be used for curing coated eyeglasses. These coatings are very thin and use photoinitiators which are designed not to yellow. This requires using lower wavelengths in the 365 nm region. Here too, the UV-LED array can be moved across the eye glass lens rather than to create an array that is the size of the eyeglasses.

An ink jet application can be provided with a high power UV-LED array to cure UV curable ink at a different rate than the printing. Also, a plurality of high power UV-LED arrays can be positioned to create an even more uniform distribution of high intensity UV light. The distribution of the UV light can be based on distance. The relationship of one UV-LED array to the next can directly related to the intensity profile curve of the UV light.

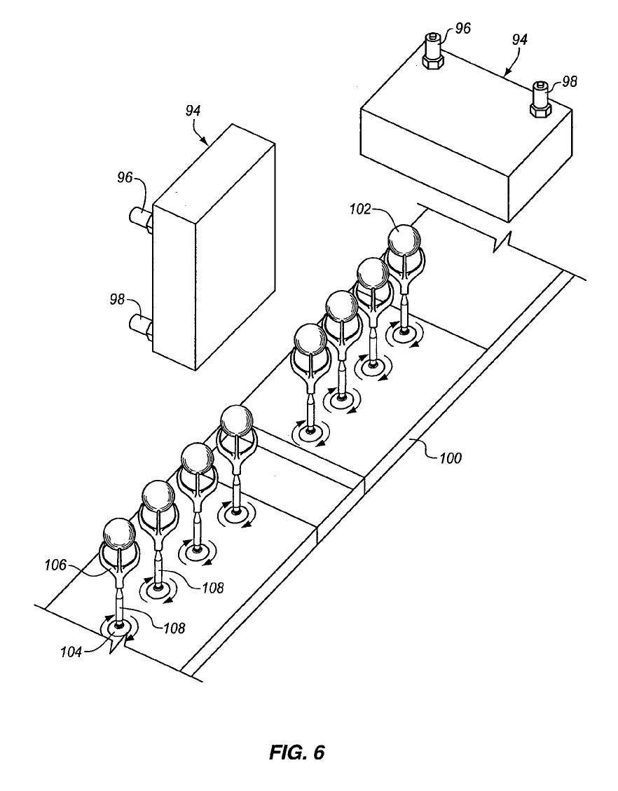

FIG. 6 shows a high power UV-LED assembly 94 with a water inlet 96 and a water outlet 98 and staggered UV-LED arrays hidden from view on the underside of the assembly, mounted above a conveyor 100 carrying golf balls 102 which can be rotated by a spinning platform 104 on the conveyor 100. The spinning platform can have arcuate fingers 106 that extend upwardly from a rotatable (rotating) shaft 108. In this embodiment, a second high power UV-LED assembly 94 is positioned adjacent the conveyor 100 and perpendicular to the first assembly 94 so that UV light can be emitted and directed from two directions along one or more UV light paths to uniformly distribute UV light onto the gold balls 102 to more uniformly and evenly cure the UV curable printing (ink), coating or adhesive on the golf balls 102. The golf balls 102 can be uniformly, partially, or fully polymerized, set and cured when rotating, spinning or when stopped (stationary) on or off the conveyor 100. The golf balls 102 can be coated and protected with a clear transparent scratch-resistant UV curable coating and/or can be printed or labeled with a name and/or logo and/or design in a UV curable ink, either black ink or one or more colored inks

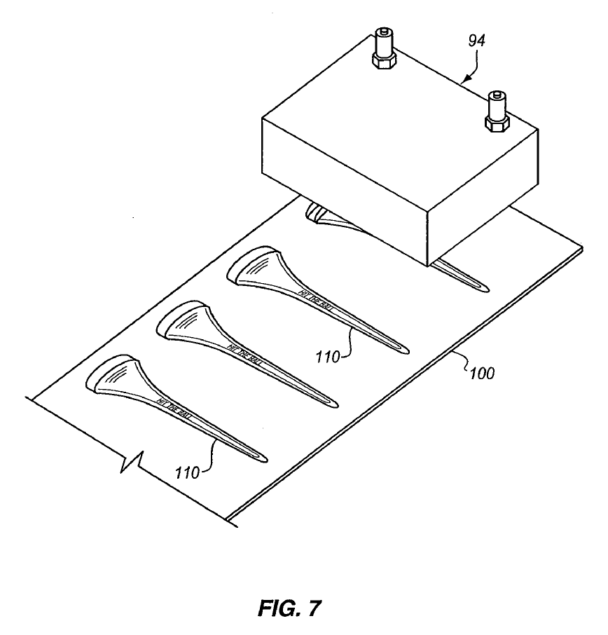

In FIG. 7, a high power UV-LED assembly 94 is positioned above a conveyor 100 carrying golf tees 110. In this embodiment, a UV curable coating or ink on the golf tees 110 can be uniformly partially or fully polymerized, set and cured as the conveyor 100 passes in a UV light path underneath the high power UV-LED assembly 94. If desired, another high power UV-LED assembly 94 also can be positioned on each side of the conveyor 100 for emitting, directing and applying UV light onto the golf tees 110 in another UV light path(s) from different directions.

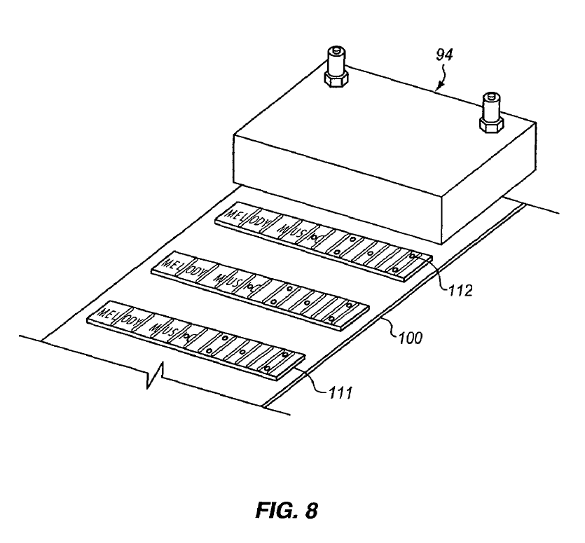

In FIG. 8, a high power UV-LED assembly 94, is positioned over the conveyor 100 carrying string instruments 111 with necks 112 or other portions having UV curable coating, adhesive, or printing material thereon. The string instrument necks 112 can be coated with a decorative UV curable coating or a clean transparent scratch-resistant UV curable coating. Various string instruments can be cured in this manner, such as: violins, violas, cellos, base violins, double base violins, guitars, mandolins, balalaikas, ukuleles, harps, etc. The high power UV-LED assembly 94 emits bursts or blasts of UV light in a light path to uniformly partially or fully polymerize, set and cure the UV curable coating on the string instruments.

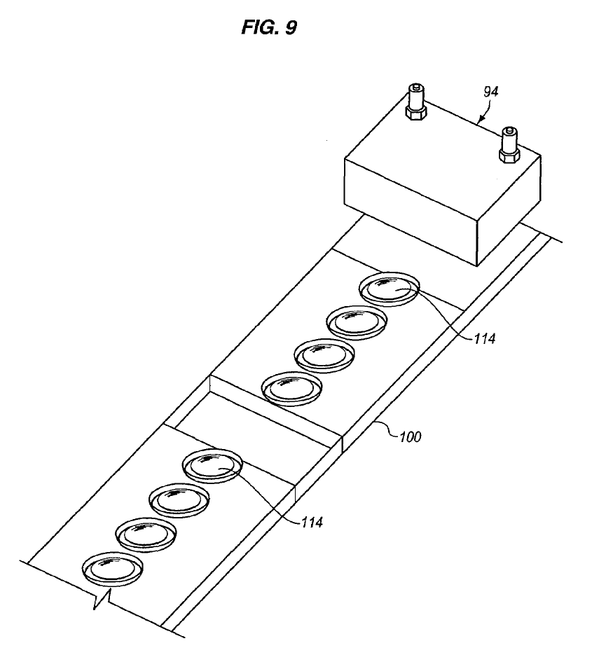

FIG. 9, a high power UV-LED assembly 94 is positioned above a conveyor 100 carrying eye glass lenses 114 which have been coated with a scratch-resistant UV curable coating. The eye glass lenses 114 can be coated with a UV curable coating comprising a color tint (amber, grey, etc.) and/or clear transparent protective scratch-resistant coating and/or a UV-blocking coating. The eye glass lenses can be uniformly partially or fully polymerized, set and cured while rotating or stopped (stationary) on or off the conveyor 100.

FIG. 10 illustrates a high power UV-LED assembly 94 positioned above a conveyor 100 carrying UV curable soft hydroscopic contact lenses 116 containing a UV curable material or coating. The UV curing apparatus uniformly distributes high intensity UV light on the contact lenses to enhance uniform curing and polymerization of the UV curable material or coating on the contact lenses. It will be appreciated that, for the sake of illustration, only a single line of contact lenses 116 is shown for illustrating the UV curing method and apparatus of the present invention. However, in practice, a plurality of lines of contact lenses 116 are carried on the conveyor 100. The contact lenses 116 can be coated with a UV curable coating comprising a UV curable color tint and/or can be coated with a clear transparent protective scratch-resistant UV curable coating. The contact lenses 116 can be cured while spinning, rotating or stopped (stationary) on or off the conveyor 100.

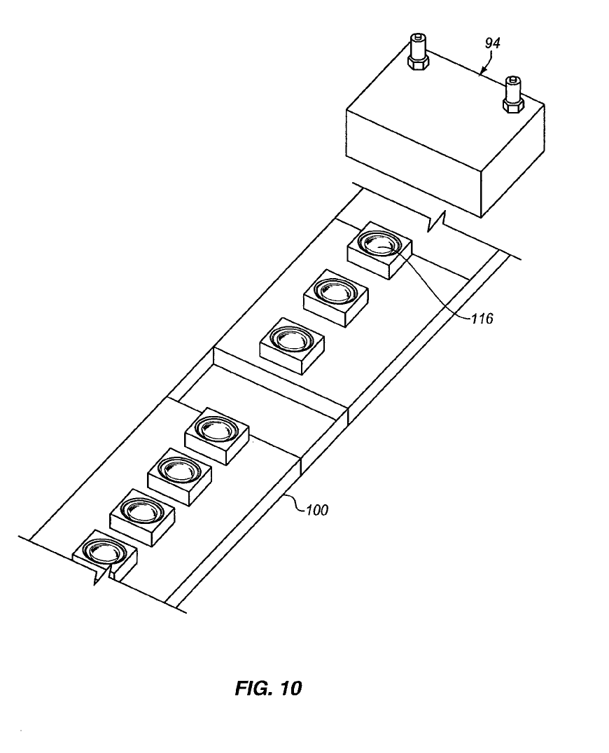

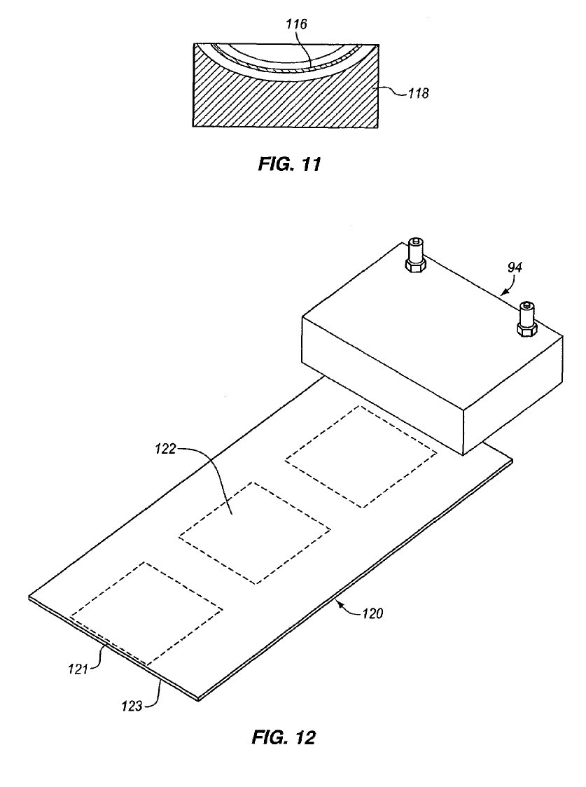

FIG. 11 is a sectional view of one type of contact lens holder 118 or suction cup which can be used on the conveyor 100 for holding and carrying the contact lenses 116.

In the embodiment of FIG. 12, a sheet 120 or roll of peelable labels or peelable stamps 122 is positioned on a conveyor (not shown) below the high power UV-LED assembly 94. The sheet of peelable (removable, strippable or detachable) labels or stamps includes a silicon release liner 121 or other UV curable releasable adhesive sandwiched between an upper layer of labels 122 or stamps, and a lower backing layer 123. The peelable labels or peelable stamps can be readily peeled, removed, stripped or detached from the release liner 121 on the sheets 120.

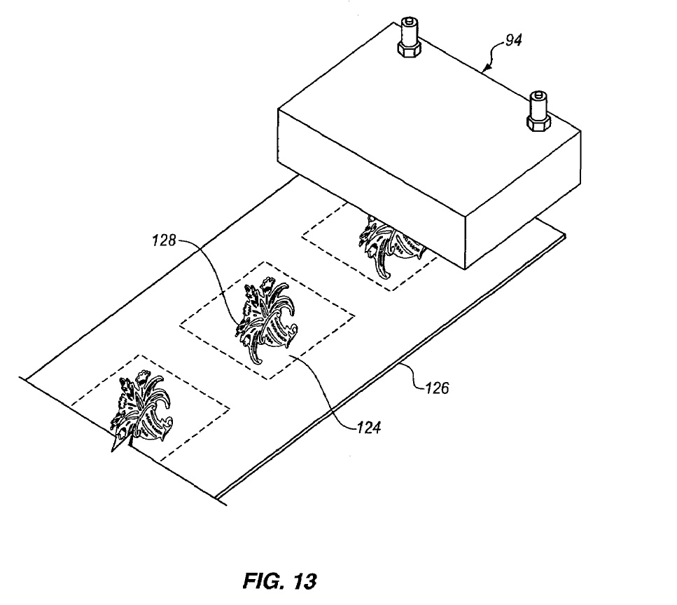

The embodiment of FIG. 13 is similar to the embodiment shown in FIG. 12 but with decorative peelable labels 124 or peelable stamps on a sheet 126 or roll. The peelable labels or stamps have UV curable print (ink) 128 (black or one or more colors) on the front or upper surface thereof which is cured by the high power UV-LED assembly 94.

The high power UV-LED assembly 94 can emit intermittent pulses or blasts of UV light along a UV light path to uniformly fully or partially polymerize, set, and cure the UV curable ink or UV curable adhesive on the peelable stamps 122 (FIG. 12) or peelable labels 124 (FIG. 13).

In the embodiment of FIG. 14, wooden, metal or composite doors 130 are positioned horizontally upon or hung vertically from a conveyor 100. The doors are coated with a UV curable coating such as a clear transparent scratch-resistant UV curable coating or a colored

UV curable coating providing a UV curable paint or UV curable stain. The high power UV-LED assembly 94 is positioned to emit and uniformly distribute and apply UV light along one or more UV light paths to each surface of the doors 130 to uniformly fully or partially cure, set and polymerize the UV curable coating on the doors 130.

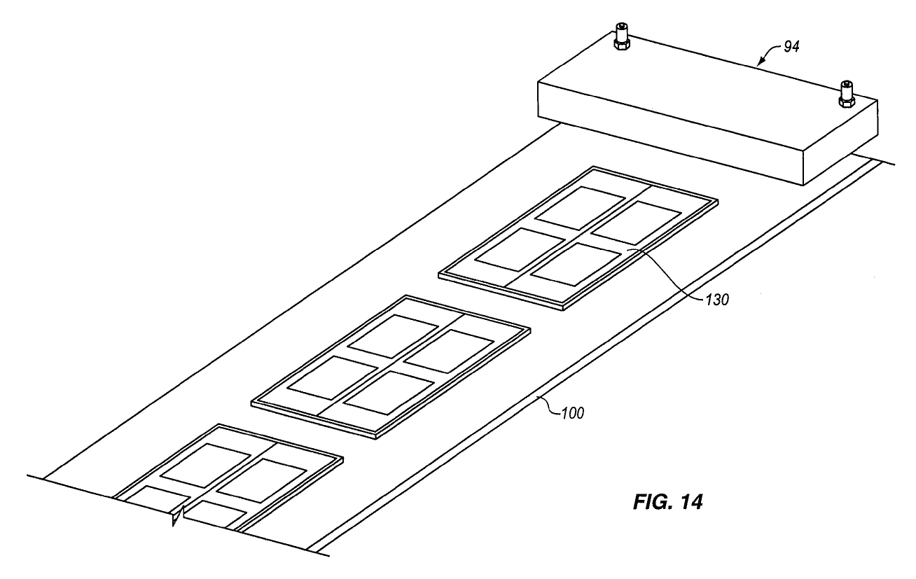

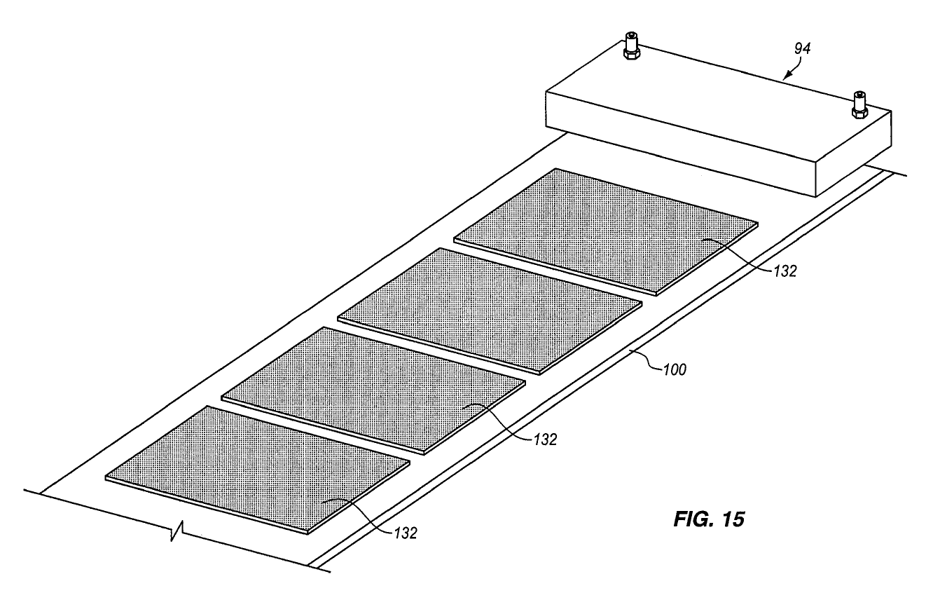

In the embodiment of FIG. 15, wooden, metal, stone, or composite counter tops 132 are positioned on a conveyor with their top surfaces facing upwardly and below a high power UV-LED assembly 94. The top surfaces of the countertops 132 are coated with a UV curable coating such as a clear transparent scratch-resistant UV curable coating or a colored UV curable coating. The high power UV-LED assembly 94 can emit intermittent pulses or blasts of UV light along one or more UV light paths to uniformly fully or partially cure, set, and polymerize the UV curable coating on the countertops 132.

Other products with a UV curable coating, ink or adhesive thereon can cured on a conveyor by using one or more super high power UV-LED modules in a manner generally similar to that described above.

In all the embodiments shown in the drawings and/or described in the specification, it is be understood that one, two, or three or more super high power UV curing modules providing a UV curing apparatus with high intensity UV-LED chips that emit high intensity

UV light can be positioned over and on either or both sides of the path of travel of the UV curable products, articles, inks, coatings, adhesives, or other objects in a manner to more uniformly distribute the UV light along one or more UV light paths on the UV curable products, articles, inks, coatings, adhesives, or other objects to increase uniform curing and polymerization of the UV curable products, articles, inks, coatings, adhesives, or other objects. The super high power UV curing modules providing a UV curing apparatus with high intensity UV-LED chips that emit high intensity UV light can also extend and be positioned entirely transversely across the conveyor and/or include staggered arrays of high intensity UV-LED chips so there are no light gaps emitted on the UV curable products passing below the super high power UV-LED modules. If desired, the super high power UV curing modules can have more or less than 21 high intensity UV-LED chips that emit high intensity UV light.

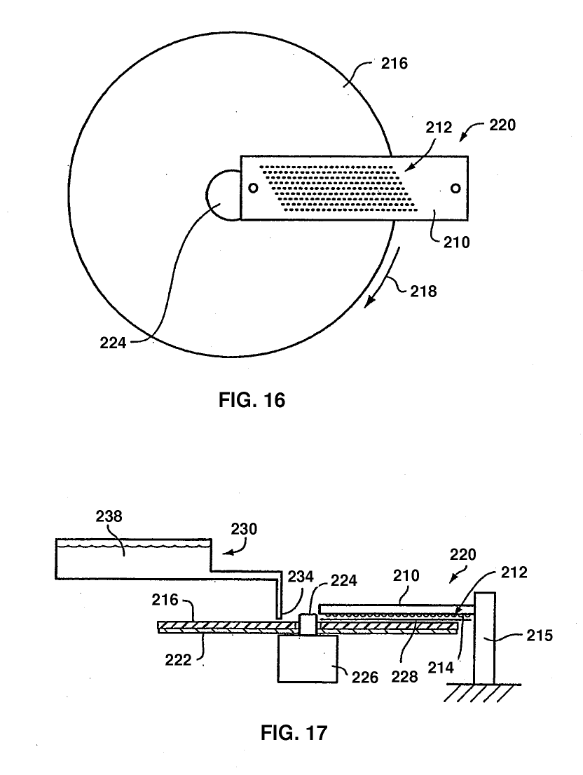

Referring now to FIG. 16, there is illustrated therein a generally rectangular-shaped, horizontal, substantially planar or flat, fixed panel 210 mounting an array 212 of staggered, offset UV-LED chips 214. The UV-LED chips 214 are arranged in staggered rows and mounted to the panel 210 such that the UV-LED chips 214 in one row are adjacent spaces between UV-LED chips 214 in an adjacent row. It will be understood that the array 212 shown on the upper side of the panel 210 is for the convenience of showing the array 212 and that actually, the array 212 of UV-LED chips 214 are mounted on the underside of the panel 210. The array 212 of UV-LED chips 214 is better shown in FIG. 2. The panel 210 can be supported by an upright vertically disposed support structure in the form of a cantilevered base 215 (FIG. 2), so that the panel 210 can be positioned over a generally disk-shaped product 216, or, simply a disk 216. The arrow 218 in FIG. 1 indicates the direction of rotation of the disk 216 in a UV-LED chip apparatus 220 including the panel 210 for curing UV photo initiators on or in the disk 216.

As shown in FIG. 17, the apparatus 220 can include a support pad 222 for supporting the disk 216. The support pad 222 can be fixed to an output shaft 224 at one end of a motor 226. The motor 226 can be energized periodically to rotate a disk 216 placed on the support pad 222 to enable UV light from the UV-LED chip array 212 to cure an UV curable product, article, ink coating or adhesive in or on the disk 216. Between the array 212 of UV-LED chips 214 and the disk 216 there can be positioned a glass or plastic sheet or plate 228 for protecting the UV-LED chips in the array 212 from splatter.

The UV-LED chips 214 are preferably arranged in an offset staggered array 212 on at least one panel 210. If desired, at least one row of UV LED chips 214 can emit light in the visible light spectrum whereby a user can visually determine that power is being supplied to the array 212 of UV LED chips 214.

Further, a heavier than air or lighter than air, non-oxygen, non-combustion supporting gas can be provided in the area between the panel and the product to enhance UV curing. Also, the gas can be circulated by a fan to enhance cooling of the UV-LED chips 214 and heat dissipating fins can be mounted on the top side of panel 210 to further enhance cooling of the UV-LED chips 214.

Also shown in FIG. 17, is a dispenser 230 for dispensing a liquid 238 having one or more UV photo initiators therein onto the upper surface of the rotating disk 216. The dispenser 230 is preferably positioned above the disk 216 and can have a dispensing point 234 near the center of the disk 216 so that liquid 238 dispensed can flow by centrifugal force radially outwardly to a periphery of the disk 216 as the disk 216 rotates. At the same time, the UV curable liquid coated portion of the disk 216 passing beneath the array 212 of UV-LED chips can be cured, polymerized and solidified, by the UV light emitted from the UV-LED chips 214.

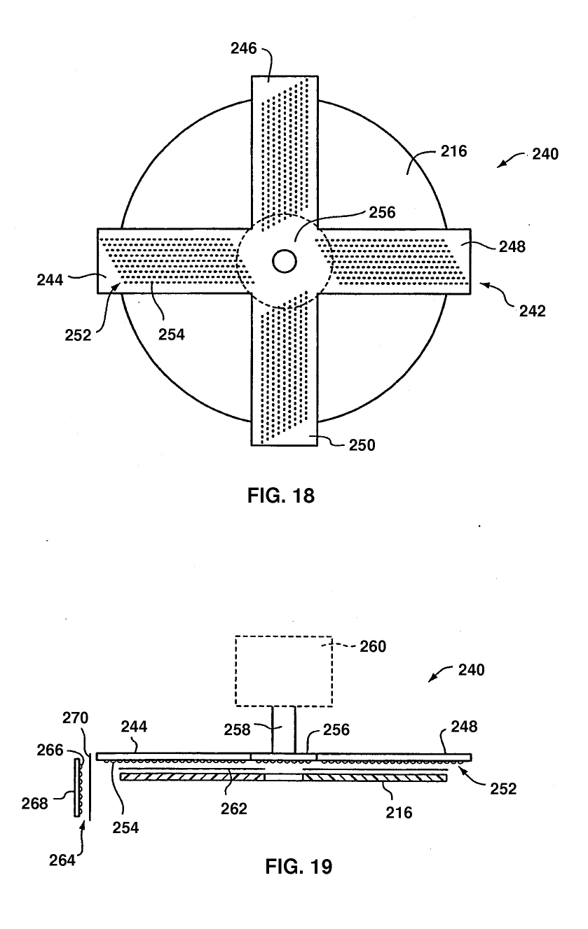

In FIG. 18, there is illustrated another UV-LED chip apparatus 240 for curing UV photo initiators in or on a stationary or fixed disk 216. As shown, the apparatus 240 includes a cross-shaped or plus shaped structure 242 including four rotatable, generally horizontal, substantially flat or planar portions or panels 244, 246, 248 and 250, each mounting an array 252 of UV-LED chips 254 and a center panel portion 256. In its simplest form, the structure 240 can include at least one elongated panel 244, 246, 248 or 250. The UV LED chips 254 are preferably arranged in an offset staggered array on at least one panel 244, 246, 248 or 250. Also, while the arrays 252 are shown in FIG. 3 on the upper side of each panel portion 244-250, it will be understood that this is only for the convenience of showing the arrays 252 and that actually, the arrays 252 are mounted on the underside of each panel portion 244-250, as better shown in FIG. 4.

In the apparatus 240 of FIG. 18 or 19, the center panel portion 256 is shown integral or connected to the panel portions 244-250 having the four arrays 252 of UV-LED chips, and is mounted to a shaft 258 at one end of a motor 260, so that the panel portions 244-250 and the arrays 252 can be rotated relative to the disk 216. It will be understood that a suitable support can be provided for the disk 216, such as a pedestal (not shown).

If desired at least one row of UV LED chips 254 can emit light in the visible light spectrum whereby a user can visually determine that power is being supplied to the array (s) 252 of UV LED chips 254.

Further, a heavier than air or lighter than air, non-oxygen, non-combustion supporting gas can be provided in the area between the panel portions 244, 246, 248 and 250 and the product to enhance curing. Also, the gas can be circulated by a fan to enhance cooling of the UV-LED chips 254 and heat dissipating fins can be mounted on the top side of the panels 244-250 to further enhance cooling of the UV-LED chips 254.

Advantageously, in the apparatus 240 of FIG. 19, a glass or plastic plate 262 is positioned between the UV-LED arrays 252 mounted on the undersides of the four panel portions 244-250 and the top of the disk 216. The disk 216 can have one or more UV curable photo initiators in or on the upper surface of the disk 216.

In the apparatus 240 of FIG. 19, there is provided at least one, generally vertically arranged, auxiliary array 264 of UV-LED chips 266 that can be mounted on a generally upright vertical panel 268 positioned adjacent the periphery of the disk 216 to provide curing light at the side or periphery of the disk 216. Also, a plastic or glass sheet or plate 270 can be positioned between the auxiliary array 264 and the disk 216 to shield the UV-LED chips 266 from splatter.

If desired, the upright panel 268 (FIG. 19) can be attached to and/or depend from one of the horizontal panel portions 244-250. Alternatively, each of the horizontal panel portions 244-250 can have an upright panel 268 attached thereto and/or depending therefrom, with the shielding sheet or plate 270 attached to the upright panel(s) 268 in front of the array 264.

The glass or plastic sheets described above for the apparatus of FIGS. 17 and 19 are preferably transparent or translucent, as well as rigid or semi-rigid, to provide impact-resistant light transmissive barriers to protect and shield the UV LED chips from splatter, dust, particularly, liquid containing UV photo initiators and other liquids.

The disk-shaped product or the at least one elongate panel can be rotated a predetermined number of times between two and twenty (20) to enhance polymerization and curing of the UV curable photo-initiators. Insertion and ejection mechanisms can be provided for sequentially moving a disk-shaped product onto and off of the stationary or rotatable support pad or pedestal in a mass production operation of the apparatus of the present invention.

Among the many advantages of the rotary UV curing method and apparatus of the invention are:

1. The disk-shaped product or at least one panel having an array of offset staggered UV-LED chips thereon can be rotated.

2. A transparent or translucent glass or plastic shield can be provided for maintaining the UV-LED chips free from debris.

3. A non-oxygen gas can be provided for enhancing curing and can be circulated to enhance cooling of the UV-LED chips.

4. Outstanding curing.

5. Excellent results.

6. Greater product output.

7. Super quality.

8. Fewer defective products.

9. User friendly.

10. Economical.

11. Efficient.

12. Effective.

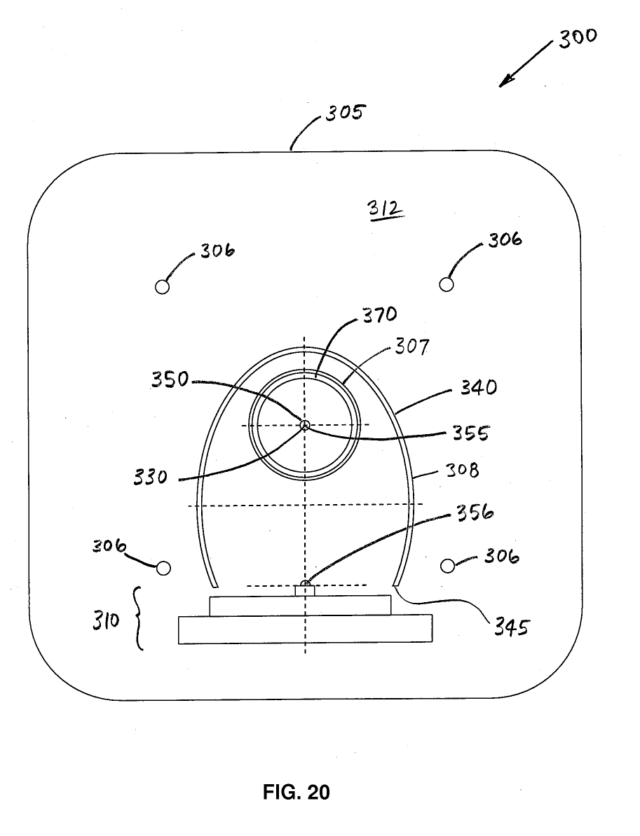

Turning now to the embodiment of FIG. 20, there is shown a rotatably indexable and stackable UV-LED module 300 for directly and reflectedly UV curing an elongated member 350 or any UV-curable ink, coating or adhesive applied thereon. Module 300 includes mount plate 305, UV-LED light source 310, and elliptically-shaped reflector 340 for reflecting UV light emitted from UV-LED light source 310 upon elongated member 350.

UV-LED light source 310 includes one or more UV-LED's, each having a dominant wavelength lying in the range of approximately 180 nm to approximately 420 nm within the ultraviolet and visible spectrums. In one embodiment, the dominant wavelength of light emitted by UV-LED light source 310 is approximately 390 nm. In another embodiment, the dominant wavelength is approximately 395 nm. In yet another embodiment, the dominant wavelength is approximately 405 nm. UV-LED light source 310 may include, for example, a single, approximately 8 watt, high output UV-LED measuring approximately 2.60 mm×4.63 mm having a light emitting area of approximately 11.96 mm² and a dominant wavelength lying in the range of approximately 390 nm to approximately 405 nm, such as the PT-120 style of UV-LED that is available from Luminus Devices, Inc. of Billerica, Mass. UV-LED light source 310 may alternatively include super high power module 10 described above.

Module 300 may also include one or more means for cooling UV-LED light source 310. For example, module 300 may include means for circulating cooling water through UV-LED light source 310, such as the apparatus described above for high power module 10. In addition or alternatively, to help dissipate and draw off heat generated by UV-LED light source 310, module 300 may include one or more of the heat pump, heat sink, fan, and closed loop electronic controller that are taught and disclosed in U.S. Pat. No. 7,465,909, the contents of which are incorporated herein by reference.

To protect the one or more UV-LED's of UV-LED light source 310 from dust, or from liquid spray or splatter caused by or emanating from elongated member 350, which dust, spray or splatter may be sufficient to degrade the performance of the one or more UV-LED's and ultimately the curing efficiency of UV-LED light source 310, module 300 may also include a removable and replaceable transparent shield positioned between elongated member 350 and the one or more UV-LED's of UV-LED light source 310. In one embodiment, the transparent shield is positioned over the one or more UV-LED's of UV-LED light source 310. The transparent shield may be made from glass or a plastic. The transparent shield may also be configured to be disposable. In one embodiment, the transparent shield may be peeled away to expose another such shield underneath a soiled or obscured shield.

To match the relative cross sectional area of the light being emitted from UV-LED light source 310 to the relative size or thickness of elongated member 350 to optimize the amount of light energy being applied and to minimize excess heat and the required electrical energy input, UV-LED light source 310 may include a series of smaller UV-LED's formed in a linear row parallel to elongated member 350. In one embodiment, each UV-LED in the linear row has an emitting area of approximately 1 mm². In another embodiment, the collection of UV-LED's have a total light emitting area of approximately 12 mm². One of ordinary skill would recognize that the cross-sectional area of the light being emitted from UV-LED light source 310 and the number of UV-LED's thereof may be adjusted to optimally cure elongated member 350 or any UV-curable ink, coating or adhesive applied thereon.

As shown in FIG. 20, UV-LED light source 310 is positioned in proximity to elongated member 350 to directly UV cure elongated member 350 or any UV-curable ink, coating or adhesive applied thereon. The one or more UV-LED's of UV-LED light source 310 are positioned proximate to focus 356, which is one focus of an ellipse formed by elliptically-shaped reflector 340, to UV cure elongated member 350 or any UV-curable ink, coating or adhesive applied thereon. In one embodiment, one or more lenses may be positioned between elongated member 350 and UV-LED light source 310 to focus UV-LED light energy upon elongated member 350.

Elongated member 350 may comprise, for example, optical fiber 26 as described above, or any wire, tubing, hose or pipe. In one embodiment including optical fiber 26 having a “primary” UV-curable coating and a “secondary” UV-curable coating, such as DeSolite® DP-1014×S and DeSolite® 29D2-15, respectively, both of which may be applied to individual strands of optical fiber 26 and which are available from DSM Desotech, Inc. of Elgin, Ill., the fastest and most complete curing may be achieved by exposing these coatings to light having a dominant wavelength within the range of approximately 390 nm to approximately 405 nm. To maximize the speed, quality, and efficiency of curing elongated member 350 or any UV-curable ink, coating or adhesive applied thereon, elongated member 350 is positioned through aperture 307 proximate to focus 355 of elliptically-shaped reflector 340, with the one or more UV-LED's of UV-LED light source 310 being positioned at the opposite focus of elliptically-shaped reflector 340 (i.e., focus 356). In this way, light rays emitted from UV-LED light source 310 are either directly applied to elongated member 350 or reflected by elliptically-shaped reflector 340 onto elongated member 350.

Elongated member 350 is oriented generally perpendicular to, for example, a first surface of mount plate 305, such as top surface 312, and is positioned along center axis 330 formed through the center of mount plate 305 of module 300. Elongated member 350, center axis 330, and focus 355 of elliptically-shaped member 340 are each approximately coaxial with one another.

Elliptically-shaped reflector 340 may be made from aluminum, and optionally from aluminum fabricated to a highly reflective surface finish. In one embodiment, elliptically-shaped reflector 340 is made from an anodized aluminum having the ability to reflect at least 85% of the light it receives from the light sources described herein. In another embodiment, elliptically-shaped reflector 340 is made from an anodized aluminum having the ability to reflect at least 98% of the light it receives from the light sources described herein. Alternatively, elliptically-shaped reflector 340 may be made from any reflective material capable of being formed to approximate an ellipse and which is capable of withstanding relatively high temperatures that may result from the use of the types of light sources described herein. Elliptically-shaped reflector 340 may also be made from a composite material, such as a substrate coupled with a reflective material that is joined, bonded, or coated to the substrate.

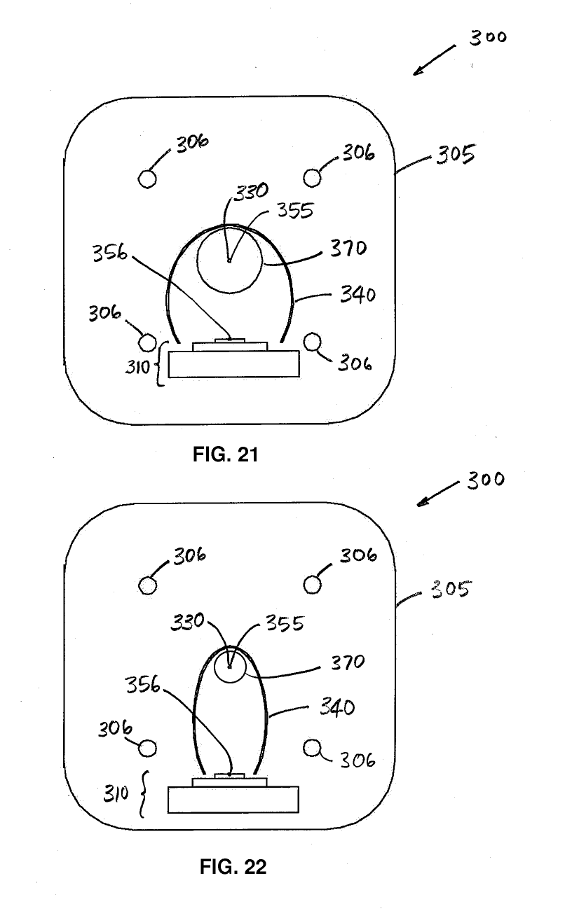

Elliptically-shaped reflector 340 may be roll-formed or otherwise shaped into the desired ellipse using, for example, approximately 0.020″ thick aluminum sheet. Elliptically-shaped reflector 340 may alternatively be fabricated by joining together two clamshell halves of a material having a reflective inner surface. Elliptically-shaped reflector 340 may also be formed from extruded aluminum cut to desired lengths. In any case, elliptically-shaped reflector 340 may also be configured to include opening 345 to permit positioning of the one or more UV-LED's of UV-LED light source 310 proximate to focus 356 of the elliptically-shaped reflector 340. As shown in FIGS. 21-22, the size of opening 345 is variable and may be configured to accommodate the size and geometry of at least the one or more UV-LED's of UV-LED light source 310 therethrough. Opening 345 may form an opening along the entire length of elliptically-shaped reflector 340. Opening 345 may alternatively form an aperture at any point along the wall of elliptically-shaped reflector 340 to maximize the amount of reflective surface.

Likewise, as shown in FIGS. 21-22, the major and minor axes of the ellipse formed by elliptically-shaped reflector 340 may be sized to accommodate different sizes of transparent tube 370 that may be positioned around elongated member 350 and within elliptically-shaped reflector 340 through aperture 307. As shown in FIG. 20, transparent tube 370 is approximately coaxial with elongated member 350, center axis 330 of mount plate 305, and focus 355 of elliptically-shaped reflector 340. In one embodiment, transparent tube 370 has approximately a 24 mm outer diameter (FIG. 21). In another embodiment, transparent tube 370 has approximately a 12 mm outer diameter (FIG. 22). Transparent tube 370 may be made from styrene, glass, or quartz depending on the range of wavelengths emitted by UV-LED light source 310. Transparent tube 370 may be made from quartz, for example, to permit transmission of wavelengths below approximately 350 nm through transparent tube 370.

During operation, the interior of transparent tube 370 may be filled with an inert gas, such as nitrogen, to create and maintain elongated member 350 in an oxygen-free environment to enhance the speed and quality of the UV cure of elongated member 350 or of the UV curable ink, coating or adhesive applied thereon.

Elongated member 350 may be drawn through transparent tube 370 from top to bottom or from bottom to top of transparent tube 370. Additionally, it should be understood that elongated member 350 may be rotated as it is moved through transparent tube 370. At the exit end of the transparent tube 370, elongated member 350 may be drawn through a valve, similar to a hemostasis valve to minimize leakage of nitrogen from transparent tube 370. If the inert gas is heavier than air, the inert gas may be injected into the top of transparent tube 370 and the valve may be located at the lower end of transparent tube 370 such that elongated member 350 is drawn through transparent tube 370 from top to bottom.

On the other hand, if the inert gas used is lighter than air, elongated member 350 may be drawn from bottom to top and the valve may be located at the top of transparent tube 370. If the inert gas is lighter than air, the inert gas can be injected into the bottom end of the transparent tube 370. Alternatively, inert gas may be circulated, either constantly or sporadically as may be needed, through the curing area of the transparent tube 370 to reduce concern of inert gas leakage or to permit horizontal orientation of stacked units of module 300.

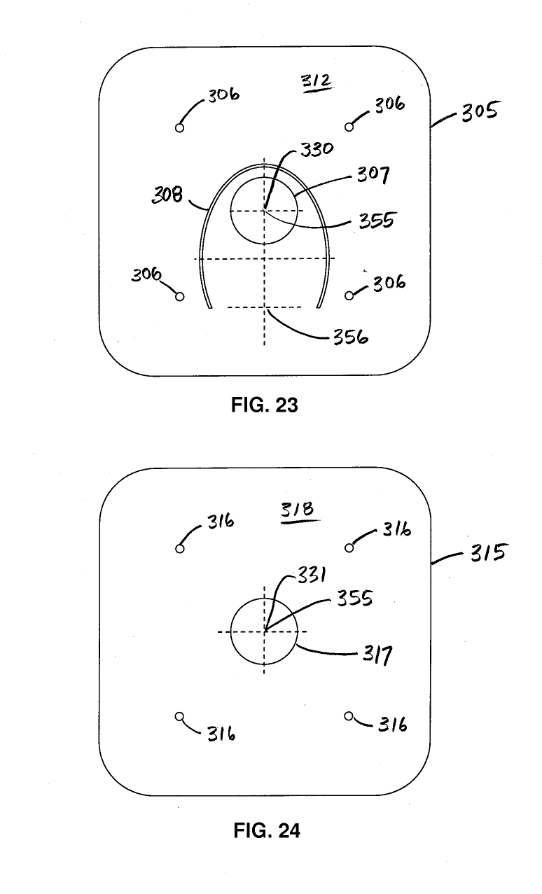

Turning to FIG. 23, mount plate 305 is constructed from approximately 0.060″ thick steel sheet, and is designed to be a stable platform upon which to removably but securely mount UV LED light source 310 and elliptically-shaped reflector 340. Mount plate 305 may alternatively be made from any material and thickness that provide a structure sufficient to support and accurately position the components herein described.

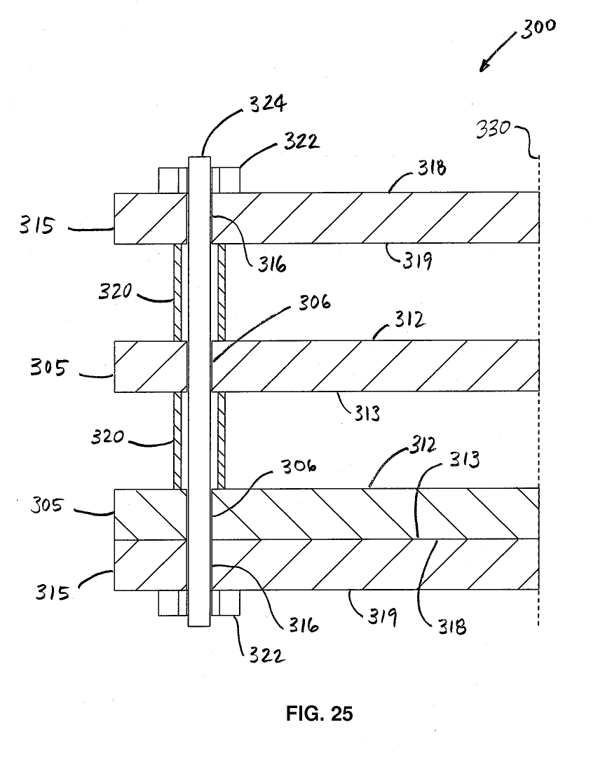

As shown in FIG. 23, mount plate 305 includes a plurality of holes 306 for receiving a plurality of rods 324 (FIG. 25) therethrough for locating and positioning multiple mount plates 305 in stacked formation with one another. Rods 324 may be fabricated from steel. Top surface 312 of mount plate 305 also includes receptacle 308 to receive and removably secure an end of elliptically-shaped shaped reflector 340. Bottom surface 313 (FIG. 25) of mount plate 305 may include a similar receptacle to receive and removably secure the opposite end of elliptically-shaped reflector 340 if stacking another mount plate 305 or another module 300 upon one another. Receptacle 308 may be formed, for example, by laser cutting a desired elliptical profile into mount plate 305 through approximately one quarter of the thickness of mount plate 305. The desired elliptical and inner and outer edge profile of elliptically-shaped reflector 340 may alternatively be formed completely through mount plate 305 to permit lengthwise insertion therethrough of elliptically-shaped reflector 340. Mount plate 305 further includes aperture 307 through which transparent tube 370 and elongated member 350 are positioned. In another embodiment, the desired outer elliptical profile of elliptically-shaped reflector 340 may be formed completely through mount plate 305 to externally support elliptically-shaped reflector 340 on its periphery and to provide additional internal clearance for installing transparent tube 370 therethrough.

To stack multiple units of module 300, as shown in the embodiment of FIG. 25, module 300 may be used in conjunction with multiple units of end plate 315 positioned on opposite ends of the stack. As shown in FIG. 24, end plate 315 includes holes 316 for receiving a plurality of rods 324 (FIG. 25) therethrough for locating and positioning multiple mount plates 305 and end plates 315 in stacked formation with one another (FIG. 25). Holes 316 are approximately coaxial with respective holes 306 in mount plate 305 when mount plates 305 and end plates 315 are in stacked formation with one another. End plate 315 further includes aperture 317 through which transparent tube 370 and elongated member 350 are positioned. Like mount plate 305, end plate 315 may be constructed from approximately 0.060″ thick steel or any thickness and material that provide a structure sufficient to support and accurately position the components herein described. In one embodiment, bottom surface 319 of end plate 315 may include the same elliptical profile as mount plate 305 through approximately one quarter of the thickness of end plate 315 to receive and removably secure the opposite end of elliptically-shaped reflector 340.

To support and maintain separation of each module 300 in the stack, sleeve 320 having an inner diameter slightly larger than holes 306, 316 is positioned over each rod 324, which itself is positioned through each hole 306, 316 of mount plate 305 and end plate 315, respectively. Plurality of rods 324 and plurality of holes 306, 316 are sized to permit easy assembly and disassembly with respect to one another while maintaining proper alignment of the stack. Nut 322 is then threaded onto respective threaded ends of rods 324 to secure the stack together. During assembly, a peripheral edge of each mount plate 305 and end plate 315 may be laid against a flat surface to help minimize “racking” of the components during assembly. At any time in the assembly process, transparent tube 370 may be fed through the plurality of apertures 307, 317 formed by the stack of modules 300, and elongated member 350 may be fed through transparent tube 370. Alternatively, multiple units of module 300 may be positioned over transparent tube 370 and elongated member 350 and thereafter connected with rods 324, nuts 322, sleeves 320, and end plates 316 to form a stack of modules 300 around transparent tube 370.

In the completed stack, elongated member 350, transparent tube 370, the center axis of apertures 307, 317, focus 355 of elliptically-shaped reflector 340, center axis 330 of mount plate 305, and center axis 331 of end plate 315 are each approximately coaxial with one another. Multiple units of module 300 may be stacked in a horizontal or vertical configuration and in such number to accommodate any desired exposure length of elongated member 350.

To permit 90 degree indexing and stacking of any module 300 relative to another to uniformly expose all sides of elongated member 350 to light emitted from UV-LED light source 350, plurality of holes 306, 316 are positioned at respective corners of an imaginary square with the center of the square being positioned coaxially with elongated member 350. In this way, 90 degree indexing of module 300 on top of and/or relative to another module 300 merely changes the angular placement of UV-LED light source 310 relative to elongated member 350 and does not appreciably change the relative distance of UV-LED light source 310 to elongated member 350. In addition, selectively indexing in 90 degree increments may assist in minimizing any damaging effects that may be caused by directing high intensity UV light emitted from one module 300 upon UV-LED's associated with other, stacked units of module 300. Ninety degree indexing may also enable using only four stacked units of module 300 to uniformly expose all sides of elongated member 350 to light emitted from UV-LED light source 310.

If the risk of damaging UV-LED's associated with adjacent stacked units of module 300 is relatively small due to the UV-LED's that are chosen for a particular curing need, module 300 may alternatively be configured to be indexed in increments less than 90 degrees. For example, although mount plate 305 of module 300 and end plate 315 are shown in the figures as having only four holes 306, 316 on top surfaces 312, 318 so as to permit only four indexing positions, module 300 may alternatively be configured to include any number of holes 306, 316 to permit more than four indexed positions of one module 300 relative to another, adjacent module 300. In one embodiment, for example, twelve holes 306, 316, respectively, are arranged in a circular pattern to permit indexing module 300 in increments of 30 degrees with respect to an adjacent module 300 while maintaining the relative distance between UV LED light source 310 and elongated member 350. In this way, more than four modules 300 may be stacked if necessary to uniformly expose all sides of elongated member 350 to light emitted from UV-LED light source 310.

It should be understood that stacking alone or stacking combined with indexing multiple units of module 300 upon one another creates a column of elliptically-shaped reflectors 340 to help maximize the opportunity for reflected light to be directed and reflected upon all sides and surfaces of elongated member 350 along the entire column of stacked units of module 300 to cure elongated member 350 or any UV-curable ink, coating or adhesive applied thereon. Multiple units of module 300 stacked upon one another may be arranged to form a helical pattern of UV-LED light along the column. Alternatively, multiple units of module 300 may be indexed relative to one another in any pattern, such as a repeating pattern or a random pattern. To further enhance the amount of light reflected within the cavity formed by the column of elliptically-shaped reflectors 340 in the stacked modules 300, bottom surface 319 of one end plate 315 and top surface 318 of the opposite end plate 315 may be configured to receive a reflective material, coating, foil, or tape.

In addition, UV-LED's capable of emitting different peak wavelengths may be mounted in different, stacked units of module 300. In this way, stacked units of module 300 may be configured to cure in a single pass multiple UV-curable inks, coatings, and adhesives applied to elongated member 350, such as, for example, a primary and a secondary coating, where the multiple UV-curable inks, coatings or adhesives each cure best at different dominant wavelengths.

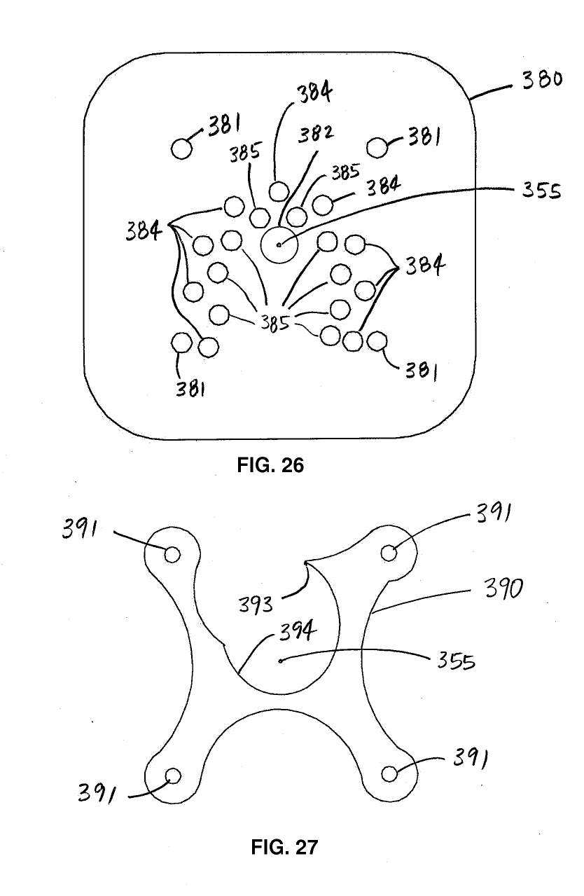

FIG. 26 shows mount plate 380, which is another embodiment for bending and securing elliptically-shaped reflector 340. Mount plate 380 is constructed of approximately 0.060″ thick steel sheet, and is designed to be a stable platform upon which to removably but securely mount UV LED light source 310 and elliptically-shaped reflector 340. Mount plate 380 may alternatively be made from any material and thickness that provide a structure sufficient to support and accurately position the components herein described.

Mount plate 380 includes aperture 382 through which transparent tube 370 and elongated member 350 are positioned coaxially with focus 355 of elliptically-shaped reflector 340.

Mount plate 380 includes a plurality of holes 381 for receiving a plurality of rods 324 (FIG. 25) therethrough for locating and positioning multiple mount plates 380 in stacked formation with one another. Mount plate 380 also includes a plurality of inner holes 385 configured to removably receive a plurality of inner pins around which a reflective material may be bent. Mount plate 380 further includes a plurality of outer holes 384 configured to removably receive a plurality of outer pins for preventing the bent reflective material from springing outward due to hysteresis. Using 0.020″ thick aluminum sheet cut to a desired height, for example, the aluminum sheet may be conformably bent around a portion of one inner pin at a time, and thereafter secured from springing outward by insertion of an adjacent outer pin. Continuing in this manner by bending the aluminum sheet around each subsequent inner pin and holding it in place with each subsequent outer pin will form elliptically-shaped reflector 340. It should be understood that any desired elliptical profile can be formed by changing the hole/pin pattern in mount plate 380.

Once elliptically-shaped reflector 340 is bent and held in position on mount plate 380, one or more inner pins may be removed entirely from inner holes 385, or replaced with shorter pins, to reduce or eliminate obstructing elongated member 350 from receiving light emitted by UV-LED light source 310 and reflected by elliptically-shaped reflector 340.

FIG. 27 shows another embodiment for bending and holding elliptically-shaped reflector 340. Holding plate 390 includes a plurality of holes 391 for receiving a plurality of rods 324 (FIG. 25) therethrough for locating and positioning multiple holding plates 390 in stacked formation with one another. Holding plate 390 also includes a “J” hook for capturing and holding one end of a reflective material thereby allowing the reflective material to be bent along a desired elliptical profile formed by edge 394. Another “J” hook (not shown) may be located at the opposite end of edge 394 to keep elliptically-shaped reflector 340 in the desired shape. At least two holding plates 390 may be used to hold elliptically-shaped reflector 340 at various points along the span of elliptically-shaped reflector 340.

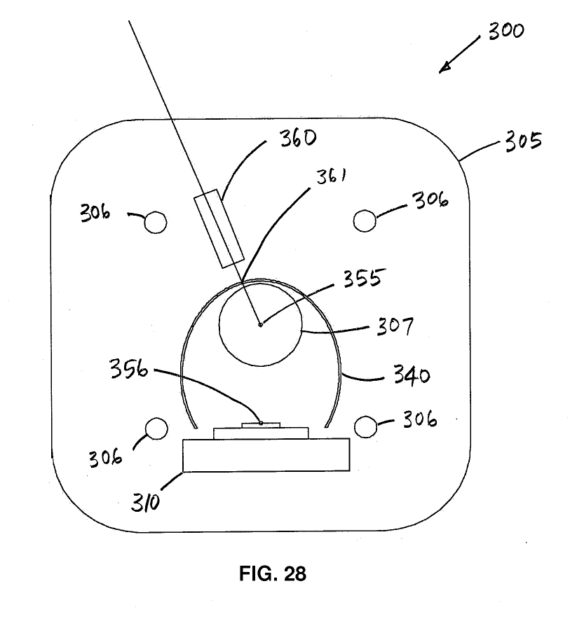

FIG. 28 shows another embodiment of module 300 having light sensor 360 usable for detecting the intensity of the light emitted by UV-LED light source 310. In this embodiment, elliptically-shaped reflector 340 includes aperture 361 through which light sensor 360 senses the amount of light emitted by UV-LED light source 310 and reflected by elliptically-shaped reflector 340. Light sensor 360 may be coupled to UV-LED light source 310, the mechanism that feeds elongated member 350 through module 300, and an electronic controller to permit closed loop control of both the amount of light output by UV-LED light source 310 and the speed at which elongated member 350 is fed through module 300. By increasing or decreasing the required electrical energy supplied to UV-LED light source 310 according to closed loop control, the amount of light output by UV-LED light source 310 may be adjusted in real-time to match the feed rate of elongated member 350 to optimally cure elongated member 350 or any UV-curable ink, coating or adhesive applied thereon while minimizing excess heat generated by UV-LED light source 310 and the required electrical energy supplied to UV-LED light source 310.

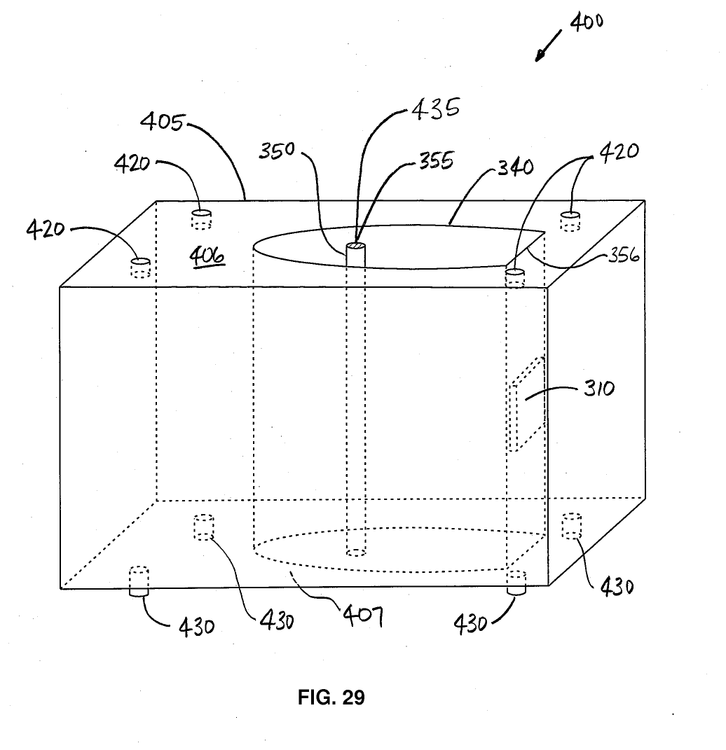

Turning now to the embodiment of FIG. 29, there is shown a rotatably indexable and stackable UV-LED module 400 for directly and reflectedly UV curing an elongated member 350 or any UV-curable ink, coating or adhesive applied thereon. Module 400 includes housing 405, UV-LED light source 310, plurality of protrusions 430 oriented on a first surface of housing 405, such as bottom surface 407, plurality of receptacles 420 oriented on an opposite surface of housing 405 and directly above protrusions 430, such as top surface 406, and elliptically-shaped reflector 340 for reflecting UV light emitted from UV-LED light source 310 upon elongated member 350.

Housing 405 of module 400 is generally formed in the shape of a cube and is configured to form a stable base upon which to removably mount UV-LED light source 310, such as, for example, super high power module 10 described above. In an embodiment, housing 405 forms a box with walls having a discrete thickness. As described above, UV-LED light source 310 is positioned in proximity to elongated member 350 to directly UV cure elongated member 350 or any UV-curable ink, coating or adhesive applied thereon. The one or more UV-LED's of UV-LED light source 310 are positioned proximate to focus 356, which is one focus of an ellipse formed by elliptically-shaped reflector 340, to UV cure elongated member 350 or any UV-curable ink, coating or adhesive applied thereon. In an embodiment, one or more lenses may be positioned between elongated member 350 and UV-LED light source 310 to focus UV-LED light energy upon elongated member 350.

To maximize the speed, quality, and efficiency of curing elongated member 350 or any UV-curable ink, coating or adhesive applied thereon, elongated member 350 is positioned proximate to focus 355 of elliptically-shaped reflector 340, with the one or more UV-LED's of UV-LED light source 310 being positioned at the opposite focus of elliptically-shaped reflector 340 (i.e., focus 356). In this way, light rays emitted from UV-LED light source 310 are either directly applied to elongated member 350 or reflected by elliptically-shaped reflector 340 onto elongated member 350.

As shown in FIG. 29, elongated member 350 is oriented generally perpendicularly to, for example, top surface 406 of housing 405 and is positioned along an axis formed through the center of housing 405 of module 400. Elongated member 350, the center axis 435 of housing 405, and focus 355 of elliptically-shaped member 340 are each approximately coaxial with one another. Transparent tube 370 may also be positioned approximately coaxial with elongated member 350, focus 355 of elliptically-shaped member 340, and center axis 435 of housing 405.

Module 400 may also include one or more means for cooling UV-LED light source 310. For example, module 300 may include means for circulating cooling water through UV-LED light source 310, such as the apparatus described above for high power module 10. In addition or alternatively, to help dissipate and draw off heat generated by UV-LED light source 310, module 400 may include one or more of the heat pump, heat sink, fan, and closed loop electronic controller that are taught and disclosed in U.S. Pat. No. 7,465,909, the contents of which is incorporated herein by reference.

To protect the one or more UV-LED's of UV-LED light source 310 from dust, or from liquid spray or splatter caused by or emanating from elongated member 350, which dust, spray or splatter may be sufficient to degrade the performance of the one or more UV-LED's and ultimately the curing efficiency of UV-LED light source 310, module 400 may also include a removable and replaceable transparent shield positioned between elongated member 350 and the one or more UV-LED's of UV-LED light source 310. In one embodiment, the transparent shield is positioned over the one or more UV-LED's of UV-LED light source 310. The transparent shield may be made from glass or a plastic. The transparent shield may also be configured to be disposable. In one embodiment, the transparent shield may be peeled away to expose another such shield underneath a soiled or obscured shield.

To stack multiple units of module 400, receptacles 420 of one module 400 are configured to matingly receive protrusions 430 from another module 400. In another embodiment, multiple units of module 400 may be stacked in a horizontal configuration using fastening mechanisms known in the art to securely join multiple units of module 400 to one another. One or more clamps, or as described above, threaded rods and nuts may be used to hold the stack together.

To permit 90 degree indexing and stacking of any module 400 relative to another to uniformly expose all sides of elongated member 350 to light emitted from UV-LED light source 310, receptacles 420 and protrusions 430 are positioned at respective corners of an imaginary square with its center being positioned coaxially with elongated member 350. In this way, 90 degree indexing of module 400 on top of and/or relative to another module 400 merely changes the angular placement of UV-LED light source 310 relative to elongated member 350 and does not appreciably change the relative distance of UV-LED light source 310 to elongated member 350. In addition, selectively indexing in 90 degree increments may assist in minimizing any damaging effects that may be caused by directing high intensity UV light emitted from one module 400 upon UV-LED's associated with other, stacked units of module 400.

If the risk of damaging UV-LED's associated with adjacent stacked units of module 400 is relatively small due to the UV-LED's that are chosen for a particular curing need, module 400 may alternatively be configured to be indexed in increments less than 90 degrees. For example, although housing 405 of module 400 is shown in FIG. 29 as having only 4 receptacles 420 on top surface 406 and 4 protrusions 430 on bottom surface 407 so as to permit only four indexing positions, module 400 may alternatively be configured to include any number of receptacles 420 and protrusions 430 to permit more than four indexed positions of one module 400 relative to another, adjacent module 400.

Receptacles 420 and protrusions 430 are each circular to mate respective units of module 400 with one another. In another embodiment, receptacles 420 and protrusions 430 are formed in any geometric shape to permit mating of respective units of module 400 to one another. In a yet another embodiment, receptacles 420 and protrusions 430 are each arranged as a group in a circular pattern on the respective top surface 406 and bottom surface 407, where the center of each circular pattern formed by receptacles 420 and protrusions 430 are coaxial with elongated member 350, to permit indexing increments less than 90 degrees between one module 400 relative to another module 400.

Housing 405 of module 400 may alternatively be formed in any configuration to permit module 400 to be receivably stackable upon, and rotatably indexable relative to, another module 400 while maintaining the desired distance of UV-LED light source 310 relative to elongated member 350. For example, instead of or in addition to receptacles 420 and protrusions 430, top surface 406 of module 400 may be formed in the shape of a shallow, square tray for receiving a similarly shaped protrusion formed on bottom surface 407 of another module 400. A tray configuration as described would yield four indexing options. The tray could alternatively be formed in the shape of a star, or any symmetrical polygon plan shape to provide a fewer or greater number of indexing positions.

It should be understood that stacking alone or stacking combined with indexing multiple units of module 400 upon one another creates a column of elliptically-shaped reflectors 340 to help maximize the opportunity for reflected light to be directed and reflected upon all sides and surfaces of elongated member 350 along the entire column of stacked units of module 400 to cure elongated member 350 or any UV-curable ink, coating or adhesive applied thereon. Multiple units of module 400 stacked upon one another may be arranged to form a helical pattern of UV-LED light along the column. Alternatively, multiple units of module 400 may be indexed relative to one another in any pattern, such as a repeating pattern or a random pattern. Whether stacked or not, end surfaces of the first and last module 400 in a stack may be covered using a reflective material to help maximize the opportunity for reflected light to be directed and reflected upon all sides and surfaces of elongated member 350.

In addition, UV-LED's capable of emitting different peak wavelengths may be mounted in different, stacked units of module 400. In this way, stacked units of module 400 may be configured to cure in a single pass multiple UV-curable inks, coatings, and adhesives applied to elongated member 350, such as, for example, a primary and a secondary coating, where the multiple UV-curable inks, coatings or adhesives each cure at different dominant wavelengths.

From the foregoing description, it will be apparent that the method and apparatus of the present invention have a number of advantages, some of which have been described above and others of which are inherent in the invention and examples.

Although embodiments of the invention have been shown and described, it will be understood that various modifications and substitutions, as well as rearrangements of components, parts, equipment, apparatus, process (method) steps, and uses thereof, can be made by those skilled in the art without departing from the teachings of the invention. Accordingly, the scope of the invention is only to be limited as necessitated by the accompanying claims.

What is claimed is:

1. An apparatus for ultraviolet (UV) curing an elongated member, such as an optical fiber, wire, tubing, tube, hose or pipe, or at least one UV-curable ink, coating or adhesive applied thereon, comprising:
at least one ultraviolet light-emitting diode (UV-LED) mounted on one side of the elongated member; and
an elliptically-shaped reflector positioned on the other side of the elongated member opposite the at least one UV-LED,
wherein the at least one UV-LED is positioned proximate to a first focus of the elliptically-shaped reflector and the elongated member is positioned proximate to a second focus of the elliptically-shaped reflector.

2. The apparatus of claim 1, wherein the at least one UV-LED comprises at least one high intensity UV-LED.

3. The apparatus of claim 1, wherein the at least one UV-LED comprises a plurality of UV-LED's formed in a linear array.

4. The apparatus of claim 1, wherein the at least one UV-LED comprises a dominant wavelength lying in the range of approximately 180 nm to approximately 420 nm within the ultraviolet and visible spectrums.

5. The apparatus of claim 1, wherein the at least one UV-LED comprises a dominant wavelength lying in the range of approximately 390 nm to approximately 405 nm within the ultraviolet and visible spectrums.

6. The apparatus of claim 1, further including a mount plate upon which the at least one UV-LED and the elliptically-shaped reflector are mounted to form a UV-LED module.

7. The apparatus of claim 6, further including a plurality of UV-LED modules positioned about the elongated member in a staggered array with the at least one UV-LED associated with a UV-LED module being rotated to an angle relative to the at least one UV-LED associated with an adjacent UV-LED module.

8. The apparatus of claim 7, wherein a distance between the elongated member and each of the at least one UV-LED in each of the UV-LED modules is approximately the same.

9. The apparatus of claim 7, wherein the angle is selectable among a plurality of angles.

10. The apparatus of claim 1, wherein the elliptically-shaped reflector is made from an anodized aluminum capable of reflecting at least 85% of the light the elliptically-shaped reflector receives from the at least one UV-LED.

11. The apparatus of claim 1, further comprising a light sensor coupled to an electronic controller for measuring a light intensity emitted from the at least one UV-LED and for adjusting the light intensity emitted from the at least one UV-LED to optimally cure the elongated member or the at least one UV-curable ink, coating or adhesive applied thereon.

12. The apparatus of claim 1, further comprising a transparent tube positioned around the elongated member.

13. The apparatus of claim 12, wherein the transparent tube comprises an inert gas therewithin.

14. The apparatus of claim 12, wherein the transparent tube is made of quartz.

15. The apparatus of claim 12, wherein the transparent tube is approximately coaxial with the elongated member and the second focus of the elliptically-shaped member.

16. An apparatus for ultraviolet (UV) curing an elongated member, such as an optical fiber, wire, tubing, tube, hose or pipe, or at least one UV-curable ink, coating or adhesive applied thereon, comprising:
an elliptically-shaped reflector positioned on one side of the elongated member; and
at least one ultraviolet light-emitting diode (UV-LED) positioned on another side of the elongated member proximate to a first focus of the elliptically-shaped reflector.

17. The apparatus of claim 16, wherein the at least one UV-LED comprises at least one high intensity UV-LED.

18. The apparatus of claim 16, wherein the at least one UV-LED comprises a plurality of UV-LED's formed in a linear array oriented generally parallel to the elongated member.

19. The apparatus of claim 16, further comprising a transparent tube positioned approximately coaxially with the elongated member and a second focus of the elliptically-shaped member.

20. The apparatus of claim 19, wherein the transparent tube comprises an inert gas therewithin.

21. The apparatus of claim 16, further including a mount plate upon which the at least one UV-LED and the elliptically-shaped reflector are mounted to form a UV-LED module.

22. The apparatus of claim 16, wherein the UV-LED module comprises an indexing and joining apparatus for rotatably indexing and engaging the UV-LED module to at least one adjacent UV-LED module.

23. The apparatus of claim 16, further including a plurality of UV-LED modules positioned about the elongated member, wherein each of the at least one UV-LED associated with the UV-LED module is positioned inline with the at least one UV-LED associated with an adjacent UV-LED module or at a selectable angle relative to the at least one UV-LED associated with an adjacent UV-LED module.

24. The apparatus of claim 16, wherein the elliptically-shaped reflector is made from an anodized aluminum capable of reflecting at least 85% of the light the elliptically-shaped reflector receives from the at least one UV-LED.

25. A method for ultraviolet (UV) curing an elongated member, such as an optical fiber, wire, tubing, tube, hose or pipe, or at least one UV-curable ink, coating or adhesive applied thereon, comprising the steps of:
positioning an elliptically-shaped reflector on one side of the elongated member;
positioning at least one ultraviolet light-emitting diode (UV-LED) in proximity to and on another side of the elongated member proximate to a first focus of the elliptically-shaped reflector; and
emitting UV light from the UV-LED onto the elongated member.

26. The method of claim 25, further including the step of positioning a transparent tube around the elongated member, the elongated member being positioned proximate to a second focus of the elliptically-shaped reflector.

27. The method of claim 26, further including the step of substantially filling the transparent tube with an inert gas.

28. The method of claim 25, further including the step of mounting the at least one UV-LED and the elliptically-shaped reflector to a mount plate to form a UV-LED module.

29. The method of claim 28, further including the step of positioning a plurality of UV-LED modules about the elongated member, wherein each of the at least one UV-LED associated with the UV-LED module is positioned inline with the at least one UV-LED associated with an adjacent UV-LED module or at a selectable angle relative to the at least one UV-LED associated with an adjacent UV-LED module.
